(19) United States
(12) Patent Application Publication
(10) Pub. No.: US 2011/0220341 A1
(43) Pub. Date: Sep. 15, 2011

(54) Method of and apparatus for empirically measuring the heat transfer rate of a ground heat exchanger (GHE) installation with its surrounding deep earth environment

(76) Inventor: John E. Kidwell, Tulsa, OK (US)

(21) Appl. No.: 12/661,176

(22) Filed: Mar. 11, 2010

(51) Int. Cl. F24J 3/08; B23Q 17/00

(52) U.S. Cl. 165/200; 29/407.01

(57) ABSTRACT

Methods for designing and constructing geothermal ground loop subsystems, and also improved methods and apparatus for in situ measuring the capacity of a ground heat exchanger installation to transfer heat energy with its surrounding deep Earth environment, during cooling and heating modes of operation of the ground source heat pumps and other geothermal systems to which such ground heat exchangers are operably connected.

### BACKGROUND OF THE INVENTION

1. Field of Invention

The present invention relates to improved methods of and apparatus for in situ measuring the capacity of ground heat exchanger installations to transfer heat energy with the surrounding deep Earth environment, and improved methods of and apparatus designing and constructing (i.e. engineering) geothermal ground loop subsystems.

2. Brief Description of the State of Knowledge in the Art

In general, most geothermal system engineering projects involve four phases; namely, analysis/planning; design; implementation/construction; and testing.

The analysis and planning phase involves determining the size of the total thermal load that the geothermal system under design must handle during heating and/or cooling modes of operation. During this stage, the thermal loads of individual heat sources and sinks in the environment are identified and modeled, to estimate total load during heating and cooling seasons. There are many excellent tools and methods currently available for supporting this phase of the systems engineering project.

During the design and construction phases, the designer and engineer currently have several ground heat exchanger technology options available, namely: “closed-loop” vertical HDPE U-tube construction; “closed-loop” vertical concentric-tube construction; and “open-loop” standing column well construction.

While open-loop standing column well heat exchangers are known to have excellent performance characteristics, they are typically very expensive to construct and can present serious environmental risks to groundwater and aquifers, making this technology an unpopular choice in many geographic regions.

In contrast, closed-loop HDPE-based U-tube ground heat exchangers, promoted by the International Ground Source Heat Pump Association (IGSHPA) have gained great popularity over the past two decades, and have recently eclipsed conventional closed-loop concentric tube ground heat exchangers, notwithstanding the fact that concentric-type heat exchangers are known to have greater heat transfer capacities than HDPE-based U-tube ground heat exchangers, due to the fact that heat transfer between incoming water and the deep Earth occurs primarily along the outer flow channel where maximal temperature gradient exists.

Various types of conventional software systems have been developed to assist in the design of ground loops constructed from vertical HDPE-based U-tube ground heat exchangers. In general, the goal of such programs is to support a ground loop design process that leads to a theoretically-based ground loop design having a minimal U-tube ground heat exchanger length, and a sufficient theoretical capacity to exchange the thermal load of the geothermal heat pump system under design, with the deep Earth. Such software systems employ mathematical heat transfer models typically based on the “infinite line source” or “finite line-source” method, which fail to consider and account for significant thermal transfers (i.e. short-circuiting) inherently occurring between HDPE piping in U-tube ground heat exchangers, only to be exacerbated in recent years by the use of thermally-enhanced grouting. In addition, such software programs typically fail to account for and model thermal resistance properties presented by boundary layers formed by laminar fluid flows along HDPE U-tube ground heat exchangers.

Also, the infinite and finite line-source models employ several critical parameters for the U-tube ground heat exchanger, namely an average thermal conductivity parameter (BTU/Hr-ft-° F.), and sometimes, an average thermal diffusivity parameter (ft²/day), both of which must be empirically measured in the field through expensive in situ testing procedures. For a given test borehole, the measured thermal conductivity (and thermal diffusivity) values are returned to the “infinite-line” or “finite-line” source model, to help the ground loop designer predict how much HDPE tubing will be theoretically required to construct a ground loop subsystem comprising multiple HDPE U-tube ground heat exchangers.

In general, conventional ground loop design methods do not employ in situ heat transfer rate (i.e. BTU/Hr) testing on actually installed U-tube ground heat exchangers, and therefore, such theoretical models, at best, can only guess at a ground loop design's theoretical capacity to exchange a predetermined rate of heat energy, between the Earth and the geothermal heat pump system, to which the ground loop subsystem will be ultimately connected upon its completion.

In short, significant barriers to progress have been created by: (i) use of HDPE-based U-Tube ground heat exchangers having relatively poor heat transfer rate characteristics requiring excessive amounts of borehole drilling to compensate for inherently low heat transfer performance with the deep Earth; (ii) use of conventional ground loop construction materials exhibiting poor thermal conductivity characteristics; and (iii) use of ground loop design programs employing mathematical models that fail to account for and properly model heat transfer cross-over between HDPE tubes, and thermal resistance properties formed by boundary layers created by laminar fluid flows along HDPE U-tube ground heat exchangers.

Accordingly, there is a great need to move beyond these barriers, and advance the state of the art in the field, while avoiding the shortcomings and drawbacks of prior art apparatus and methodologies.

### OBJECTS AND SUMMARY OF THE PRESENT INVENTION

Accordingly, it is a primary object of the present invention to provide a new and improved method of and apparatus for designing and constructing geothermal ground loop subsystems, free of the shortcomings and drawbacks of prior art apparatus and methodologies.

Another object of the present invention is to provide a new and improved apparatus for in situ measuring the capacity of ground heat exchanger installations to transfer heat energy with the surrounding deep Earth environment.

Another object of the present invention is to provide a new and improved method of in situ measuring the capacity of ground heat exchanging system installations to transfer heat energy with the surrounding deep Earth environment.

Another object of the present invention is to provide such a method of in situ measuring the capacity of concentric-tube and U-tube type ground heat exchanging systems installed in diverse deep Earth environments.

Another object of the present invention is to provide a new and improved spreadsheet enthalpy-based heat transfer rate calculator program for use in measuring the performance of ground heat exchanging systems installed in deep Earth environments.

Another object of the present invention is to provide a new and improved apparatus for heating a controlled flow of water during an enthalpy-based method of measuring the heat transfer rate of a ground heat exchanging system installed in a deep Earth environment.

Another object of the present invention is to provide a new and improved method designing and constructing a geothermal ground loop subsystem using ground heat exchangers that have been assigned heat transfer rate (HTR) performance characteristics that have been empirically-tested in particular deep Earth environments.

Another object of the present invention is to provide a recursive-type method designing and constructing a geothermal ground loop subsystem involving (i) designing a preliminary ground loop subsystem design using ground heat exchangers that have been assigned heat transfer rate (HTR) performance characteristics determined through empirical performance testing in particular deep Earth environments, (ii) then installing at least one such ground heat exchanger in a deep Earth environment at a ground loop field test site and measuring its actual heat transfer rate performance characteristics, and (iii) modifying the preliminary ground loop subsystem design using the actual heat transfer rate performance characteristics empirically determined for the ground loop field test site.

Another object of the present invention is to provide a method of and apparatus for in situ measuring the heat transfer rate between two or more ground heat exchanging systems installed within proximity of each other in a deep Earth environment.

Another object of the present invention is to provide a method of and apparatus for in situ measuring the thermal banking characteristics of a ground heat exchanging system installed within a deep Earth environment.

Another object of the present invention is to provide a method of and apparatus for in situ measuring the thermal storage capacity characteristics of a ground heat exchanging system installed within a deep Earth environment, during long-term heat transfer rate testing operations.

These and other objects of the present invention will become apparent hereinafter and in the Claims to Invention appended hereto.

### BRIEF DESCRIPTION OF THE DRAWINGS

For a more complete understanding of how to practice the Objects of the Present Invention, the following Detailed Description of the Illustrative Embodiments can be read in conjunction with the accompanying Drawings, briefly described below.

FIG. 1A is a schematic illustration view showing the portable enthalpy-based heat transfer rate (HTR) test system of the present invention connected to a geothermal ground heat exchanger installed in a deep Earth environment, during heat transfer rate (HTR) performance testing operations carried out in accordance with the principles of the present invention;

FIG. 1B is a schematic diagram of the portable enthalpy-based heat transfer rate test system of the present invention operably connected to a concentric-tube type geothermal ground heat exchanger, and showing its primary components, namely, a ground loop water heating module, a water circulation pump module, a power relay control module, a data logger/recorder, a computer running interfaced with the data logger/recorder and running a spreadsheet enthalpy-based spreadsheet HTR calculator program, and a system controller for controlling the components of the enthalpy-based heat transfer rate test system;

FIG. 2A is a schematic diagram of the portable enthalpy-based heat transfer rate test system of FIGS. 1A and 1B, illustrating the location of its temperature and pressure transducers and volume/mass flow rate meter, and the various subcomponents of the concentric-tube ground heat exchanger to which its connected by way of its system inlet and outlet pipes;

FIG. 2B is a schematic diagram of the portable enthalpy-based heat transfer rate test system of FIGS. 1A, 1B and 2A, illustrating the various subcomponents of its pumping and ground loop water heating module, including its electrically-powered heating elements, and hand-operated fluid flow balancing valve, and supplying a constant flow of water to the ground heat exchanger, at a constant inlet temperature, during heat transfer rate (HTR) performance testing operations;

FIGS. 3A and 3B set forth schematic diagrams of the portable enthalpy-based heat transfer rate test system of FIGS. 1A and 1B, shown connected to a conventional U-tube type ground heat exchanger by way of its system inlet and outlet pipes, and supplying a constant flow of water to the ground heat exchanger, at a constant inlet temperature during heat transfer rate (HTR) performance testing operations;

FIG. 4 is a schematic representation of an energy conservation balance conducted for a generalized thermodynamic system;

FIG. 4A is a schematic representation of an energy conservation balance conducted for any concentric-type ground heat exchanging system;

FIG. 4B is a schematic representation of an energy conservation balance conducted for any U-tube type ground heat exchanging system;

FIG. 5A is a schematic representation defining the system boundaries/control volume for any concentric-type ground heat exchanging system, being analyzed for energy conservation balance as illustrated in FIG. 4A;

FIG. 5B is a schematic representation defining the system boundaries/control volume for any U-tube type ground heat exchanging system, being analyzed for energy conservation balance as illustrated in FIG. 4B;

FIG. 6A is a schematic representation defining the system boundaries/control volume for temperature-controlled ground loop water heating module, being analyzed for energy conservation balance as illustrated in FIG. 6B;

FIG. 6B is a schematic representation of an energy conservation balance conducted for the temperature-controlled ground loop water heating module of FIG. 6A;

FIGS. 7A through 7D, taken together, provide a flow chart describing the primary steps of the method of measuring the heat transfer rate (HTR) capacity of a ground heat exchanging system, using the portable enthalpy-based heat transfer rate test system shown in FIGS. 1A through 2B;

FIG. 8 is table listing the specific enthalpy (h) values of sub-cooled water over a particular range of pressure and temperature values, expressed in units of [BTUs/lbm];

FIG. 9 is schematic representation of the graphical user interface (GUI) component of the spreadsheet enthalpy-based heat transfer rate (HTR) calculator program of the present invention, employing the specific enthalpy table of FIG. 8 during heat transfer rate (HTR) calculations for the ground heat exchanger (GHE) under performance testing; and

FIG. 10 is schematic representation illustrating a pair of portable enthalpy-based heat transfer rate test systems being used to measure the heat transfer rate between neighboring ground heat exchangers during long-term heat transfer rate testing of the first ground heat exchanging system.

### DETAILED DESCRIPTION OF THE ILLUSTRATIVE EMBODIMENTS OF THE PRESENT INVENTION

Referring to the figures in the accompanying Drawings, the various illustrative embodiments of the portable enthalpy-based heat transfer rate (HTR) test system, and HTR test method of the present invention, will be described in great detail, wherein like elements will be indicated using like reference numerals.

### Brief Overview on Designing and Constructing Geothermal Ground Loop Subsystems Using the Ground Loop System Engineering Methods of the Present Invention

A primary object of the present invention is to provide designers and engineers with a better way to rationally design, economically construct, and empirically test in situ the performance of a geothermal ground heat exchanger installed in a particular geological environment, using the portable heat transfer rate test system of the present invention. These system engineering methods allow designers and engineers to eliminate the need for (i) in situ soil thermal conductivity and thermal diffusivity measurements, (ii) conventional ground loop design software products, and (iii) conventional HDPE-based U-tube ground heat exchanger technology, while engineering higher quality and higher performance geothermal ground loop subsystems in diverse environments.

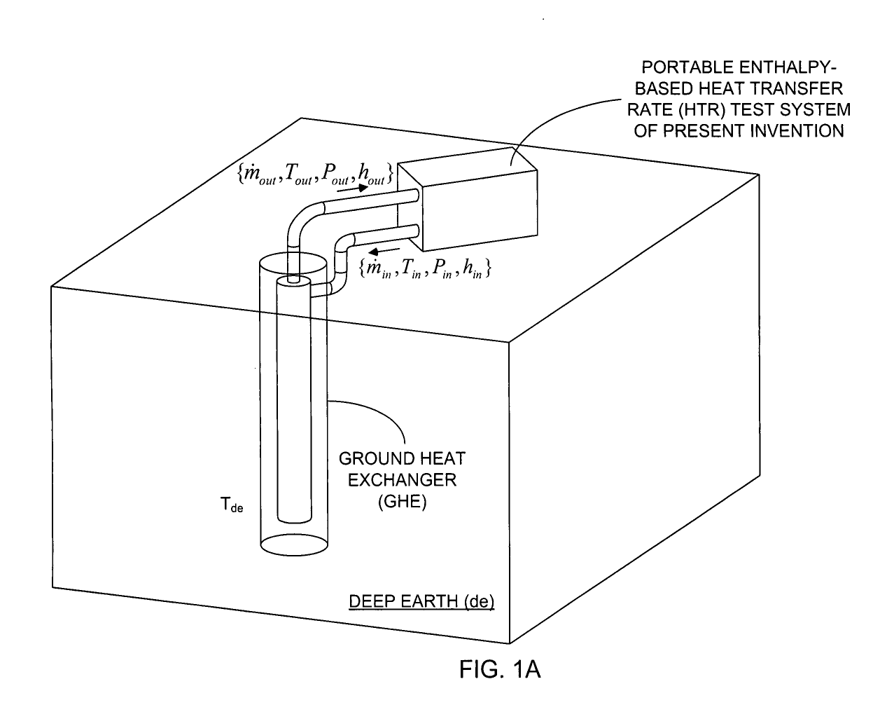

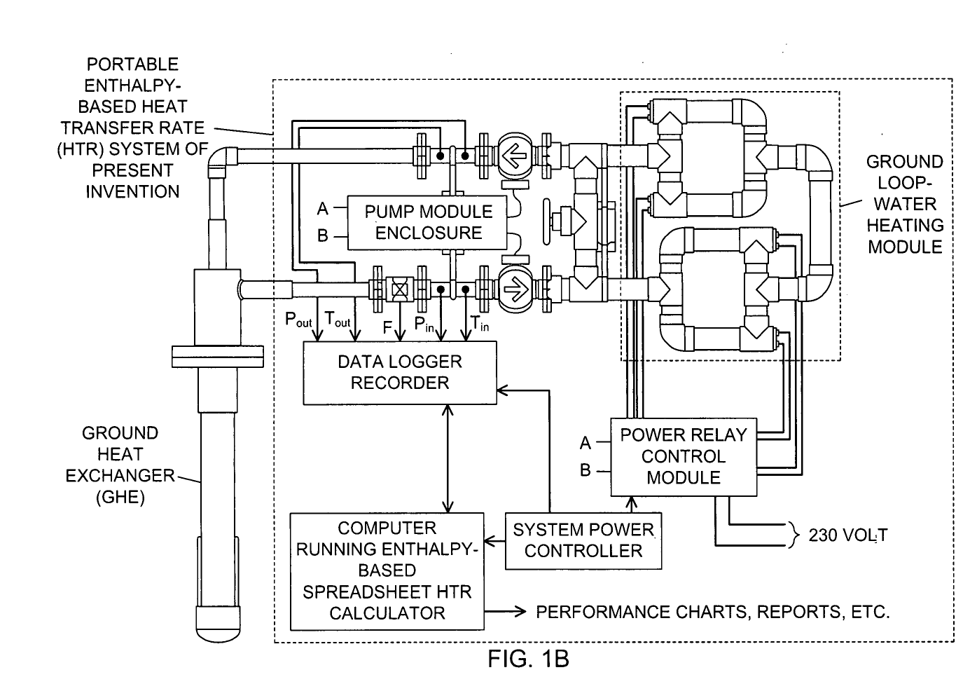

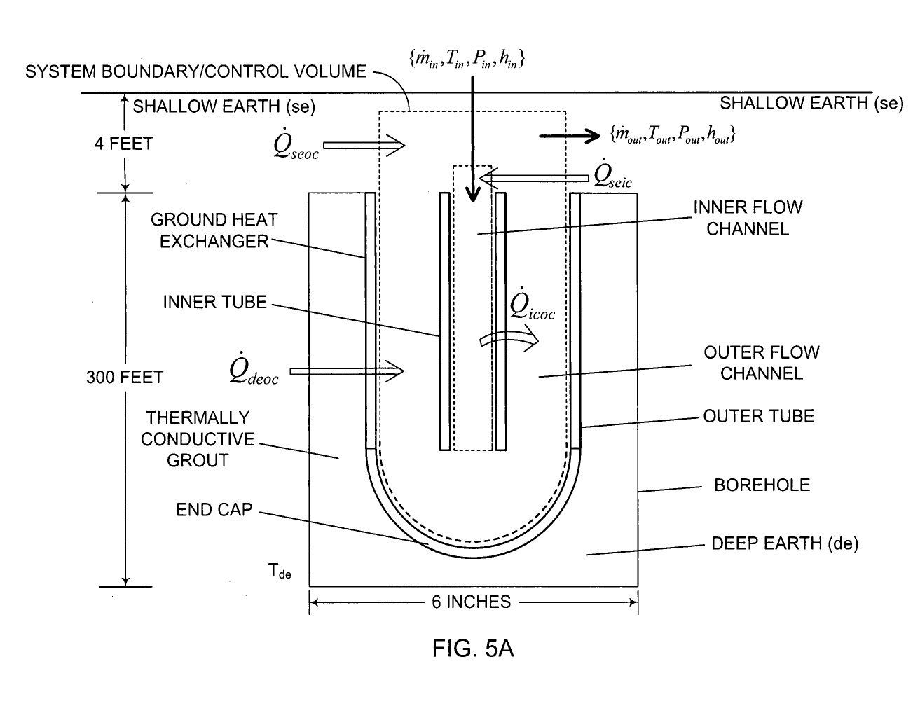

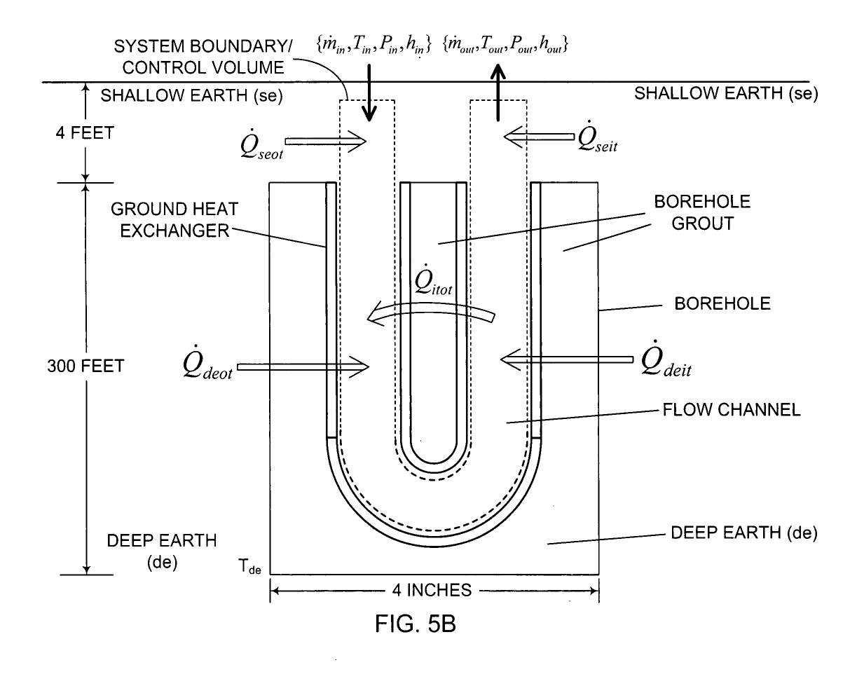

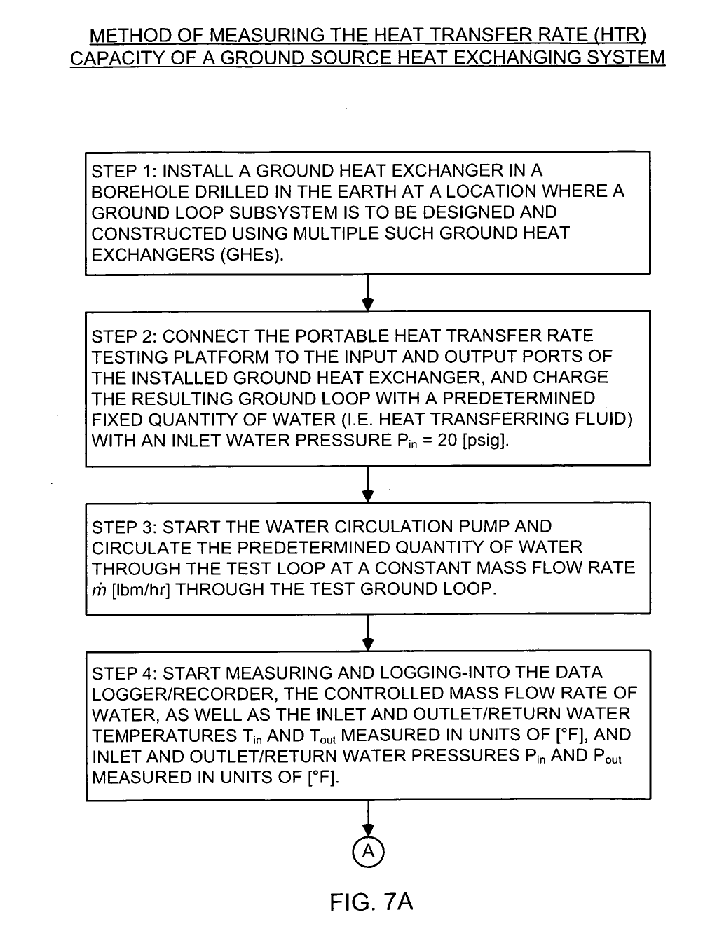

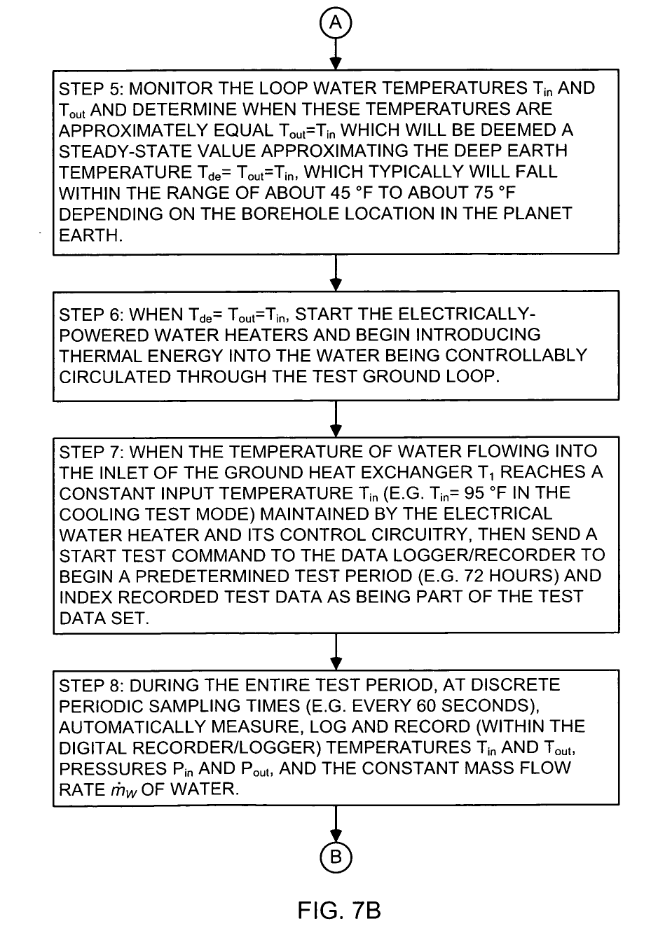

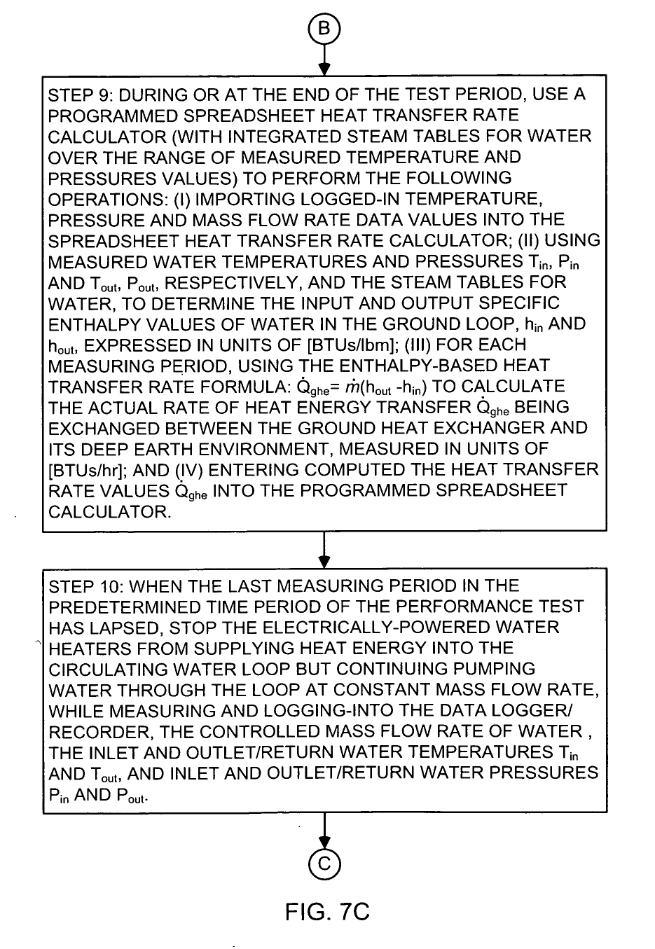

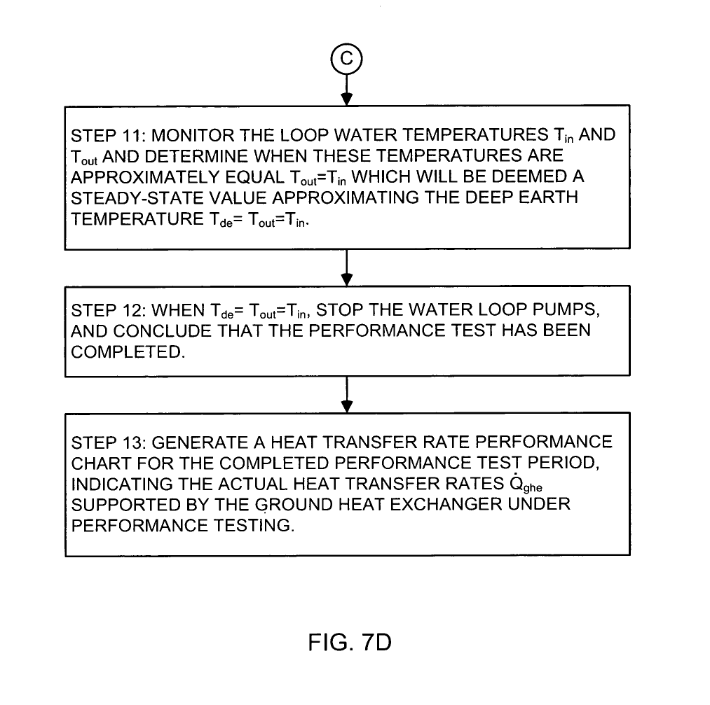

Whether practicing the library-based or recursive design/engineering methods of the present invention to be described hereinafter, it will advantageous to use of the portable enthalpy-based heat transfer rate (HTR) test system shown in FIGS. 1A through 6A, and enthalpy-based HTR test method described in FIGS. 7A through 9, to perform in situ heat transfer rate measurements on any type of ground heat exchanging system installation at a specified ground loop field test site. It is appropriate at this juncture to describe this system and method in greater technical detail below.

The Portable Enthalpy-Based Heat Transfer Rate Testing Platform and Method of Enthalpy-Based Heat Transfer Rate (HTR) Testing in Accordance with the Principles of the Present Invention

In the illustrative embodiment shown in FIG. 1A, the portable heat transfer rate (HTR) test system of the present invention is shown connected to a generalized ground heat exchanger (GHE) installed in a borehole drilled in the deep Earth environment. Such ground heat exchangers can be closed-loop concentric-tube (i.e. coaxial-flow) type ground heat exchangers as disclosed in U.S. Pat. Nos. 7,343,753; 7,347,059; 7,363,769; 7,370,488; 7,373,785; and 7,377,122; HDPE U-tube type heat exchangers as promoted by IGSHPA; open standing column well the ground heat exchangers promoted at http://www.northeastgeo.com; and other ground heat exchanger technologies known in the art.

As shown, the portable HTR test system delivers a heat energy carrying fluid, such as water, into the ground heat exchanger, the deep Earth environment exchanges heat with the heat energy carrying fluid, and water output from the ground heat exchanger is returned to the HTR test system for reheating, along the ground test loop. As shown, the thermal properties for the input water stream T_{out are} input mass flow rate \dot{m}ᵢₙ, input water pressure Pᵢₙ input water temperature Tᵢₙ and input specific enthalpy hᵢₙ which is a function of input water pressure Pᵢₙ and input water temperature Tᵢₙ. The thermal properties for the output water stream are output mass flow rate \dot{m}ₒᵤₜ, output water pressure Pₒᵤₜ output water temperature Tₒᵤₜ, and specific enthalpy hₒᵤₜ, which is a function of output water pressure Pₒᵤₜ and output water temperature hₒᵤₜ, well known in the field of water thermodynamics.

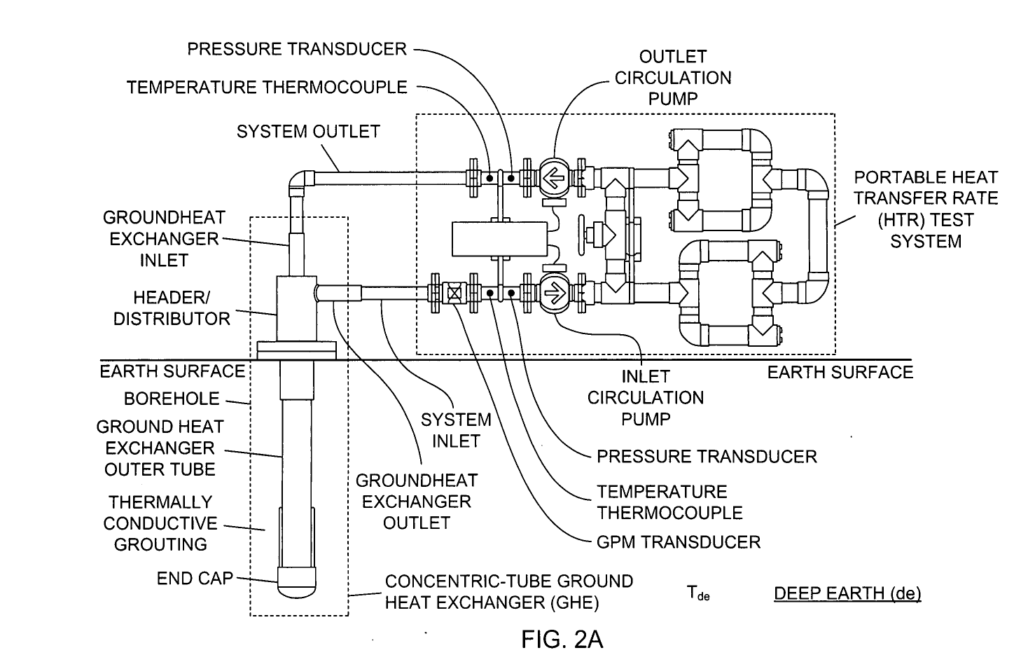

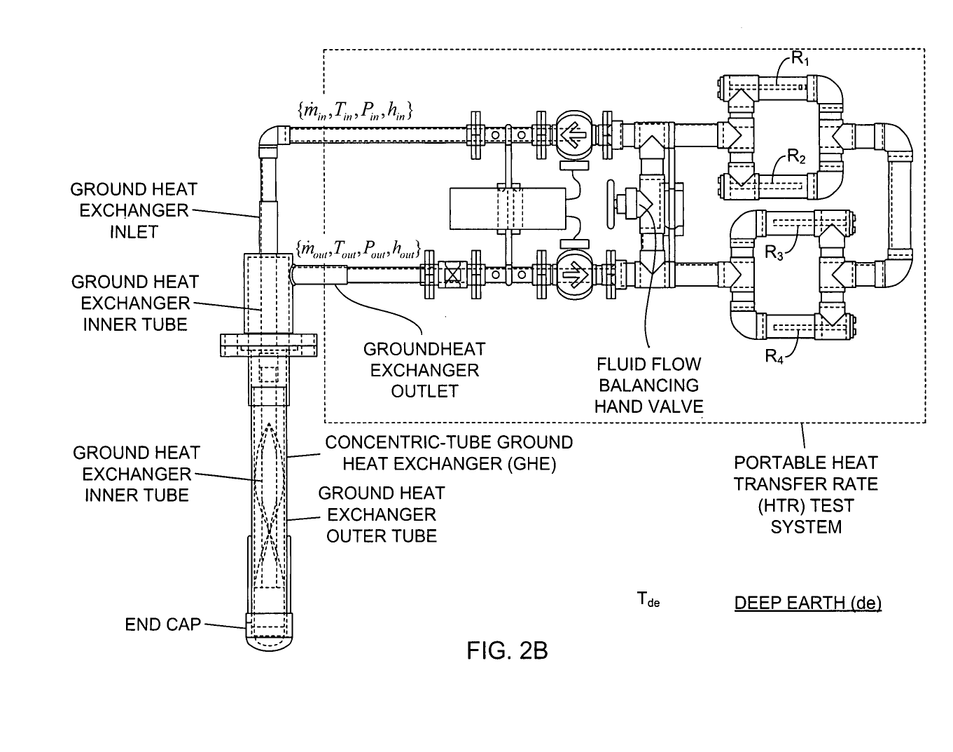

In general, the portable HTR test system of the present invention can be used to perform in situ heat transfer rate (HTR) performance measurements on any type of geothermal ground heat exchanger, described above. Two illustrative examples are given in FIGS. 1A, 1B and 2A and 2B.

In FIGS. 1A and 1B, an illustrative embodiment of the portable heat transfer rate test system is shown connected to a close-loop concentric-tube (i.e. coaxial-flow) type ground heat exchanger GHE-CT, installed in a borehole drilled in the deep Earth environment. As shown, the concentric-tube type ground heat exchanging system is filled with an aqueous-based heat transfer fluid, that is contained and circulated within a sealed underground concentrically-arranged (coaxial-flow) tube assembly. In the design disclosed in U.S. Pat. No. 7,343,753, both laminar and turbulent fluid flows are employed within the tube assembly, to efficiently and safely transfer heat energy between the geothermal heat pump unit and the Earth's crust, all year round, in a highly efficient, economical and environmentally-safe manner Typically, the concentric-tube type ground heat exchanging system is installed in a six (6) inch diameter 300 feet deep vertical borehole, but the borehole length may vary from installation to installation. Multiple ground heat exchangers of this design can be installed in 300 foot boreholes, spaced at 20 feet apart, and connected together with conventional piping below the frost-line, to meet the heat transfer rate requirements of any size geothermal heat pump or geothermal chiller project.

In FIGS. 2A and 2B, the portable heat transfer rate test system of the present invention is shown connected to a conventional-based U-Tube heat exchanger, installed in a borehole drilled in the deep Earth environment. Examples of such HDPE U-Tube type ground heat exchangers are disclosed at http://www.igshpa.org and http://www.heatspring.com. As shown, the U-Tube type ground heat exchanging system GHE-UT is filled with an aqueous-based heat transfer fluid, that is contained and circulated within a sealed HDPE U-tube configuration, installed in a borehole that is filled with grouting, that may have thermally enhanced properties. Typically, a U-Tube ground heat exchanger is installed in borehole of 4 to 6 inches in diameter, running in length from 100 feet up to 500 feet, and possibly deep in some applications. Multiple ground heat exchangers of this design can be installed in boreholes, also spaced at 20 feet apart, and connected together with conventional piping below the frost-line, to meet the heat transfer rate requirements of a geothermal heat pump project.

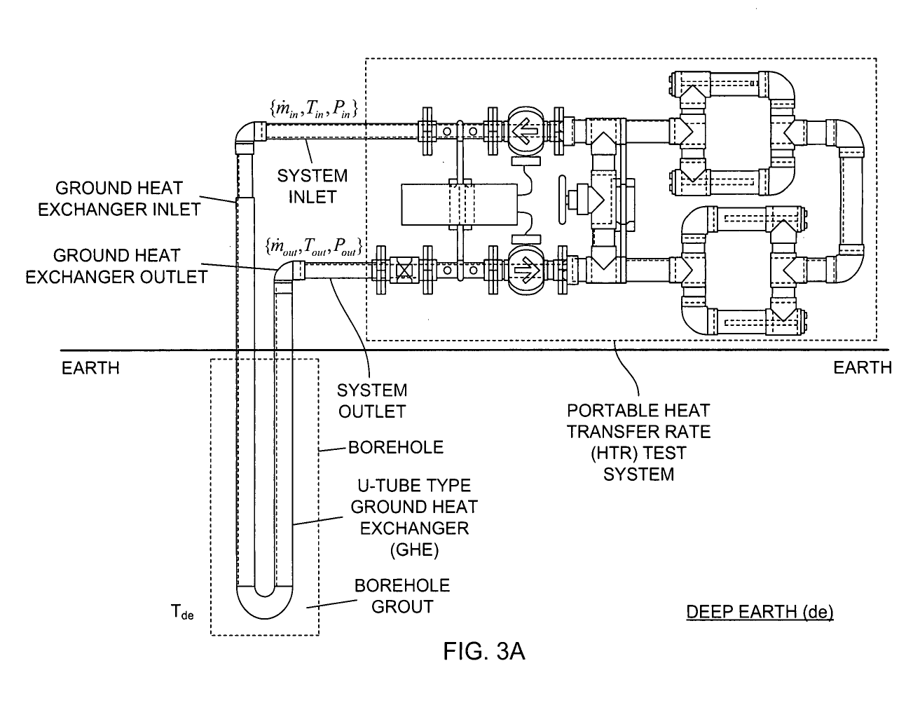

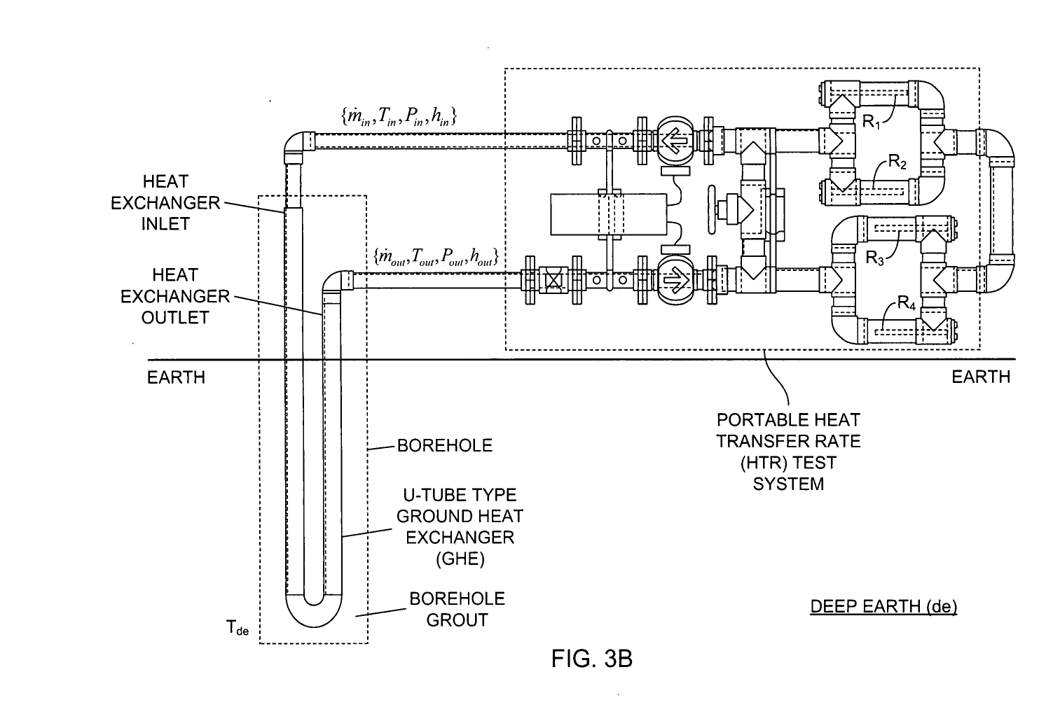

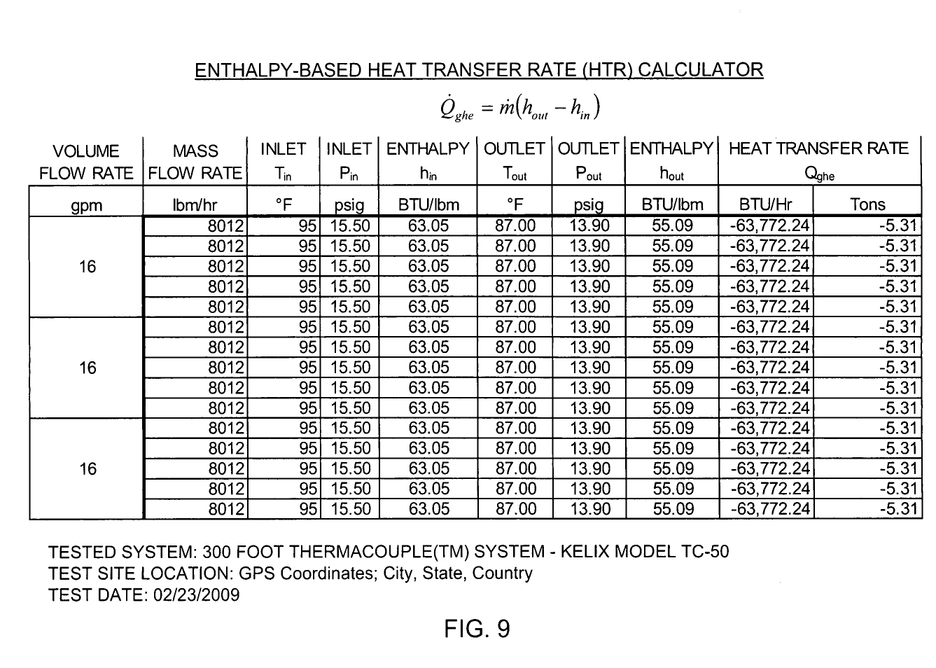

As shown in FIG. 3, the portable heat transfer rate (HTR) test system comprises a number of components, namely: inlet and outlet water circulation pumps and associated pump control module for controlling the pumps so that a predetermined quantity of water (i.e. heat transferring fluid) is circulated through the test ground loop at a constant volume or mass flow rate during the test procedure period having a duration of at least 72 hours; ground loop water heating module consisting of a flow control tube assembly provided with a hand-operated mixing valve between the inlet and outlet flow channels, and having a pair of parallel flow water heating submodules, each having a pair of electrically-powered water heating elements, characterized by resistances R1, R2 and R3, R4 and rated to operate at output power values of at least 5.5 [kilowatts], denoted by P₁, P₂, P₃, and P₄, respectively; electrical power relays and associated control module for supplying the heating elements with 230V electrical power (supplied to the test site) so that the heating elements generate thermal energy and heat up the water pumped through the flow control tube assembly so that the inlet or entering water temperature T₁ is maintained at a constant input temperature measured in units of [° F.] (e.g. T₁=95° F. in the cooling test mode of the system) during the entire 72 hour test period; a mass flow rate meter for measuring in units of [lbm/hr] the controlled mass flow rate \dot{m} of water through the test ground loop, or alternatively, a volume flow rate meter for measuring in units of [gallons/minute] the controlled volume flow rate F of water through the test ground loop, which can then be converted to a corresponding value of mass flow rate; a pair of temperature transducers (e.g. thermocouples) located on the interior surfaces of the inlet and outlet of the output ports of the apparatus, for measuring the inlet and outlet water temperature values T₁ and T₂ in units of [° F.] at discrete periodic sampling times; a pair of pressure sensors/transducers located on the interior surface of the output port of the apparatus, for measuring the inlet and outlet water pressures P1 and P₂ in units of [psig] at discrete periodic sampling times during the 72 hour test period; a digital logger/recorder for logging and recording temperatures T₁ and T₂, pressures P₁ and P₂, and the constant mass or volume flow rate of water flowing along the test ground loop, for each measuring period (e.g. every 60 seconds); a programmed micro-controller for controlling the components on the test system during testing operations; and a spreadsheet enthalpy-based heat transfer rate calculator program, illustrated in FIG. 9, running on a laptop, notebook or other portable computer system that is interfaced with the data logger/recorder using a standard data communication interface that may be wired and/or wireless, and test application requirements may require.

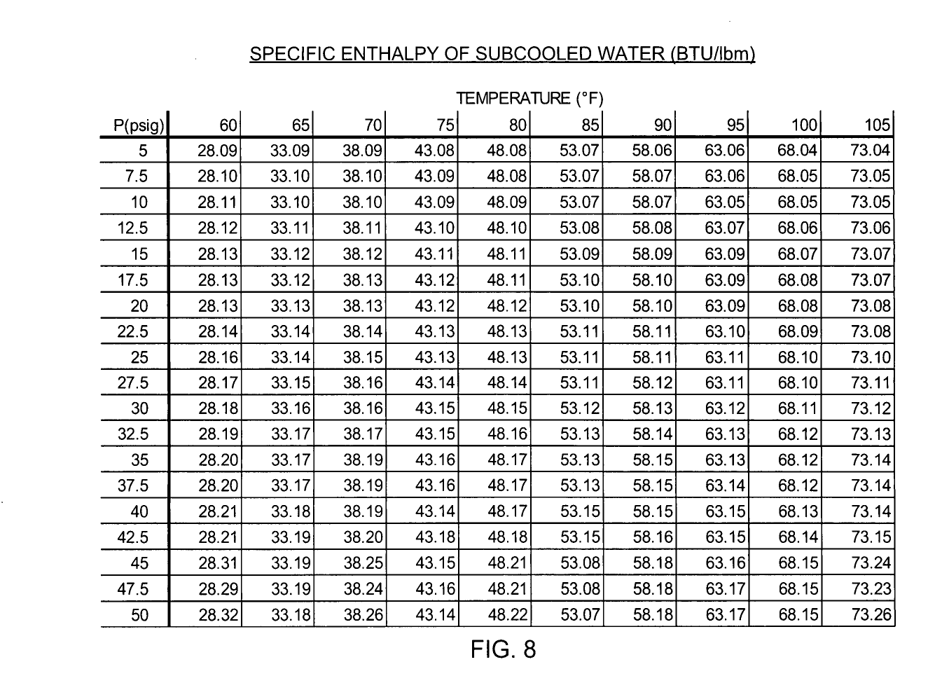

Preferably, the spreadsheet HTR calculator program has integrated a steam table for sub-cooled water over the range of measured temperature and pressure values, expected during testing operations. In the preferred embodiment of the present invention, this integrated steam table (partially) shown in FIG. 8 contains the specific enthalpy of water, known as h=f(p,T), defined as a function of temperature and pressure, in accordance with the International Association for the Properties of Water and Steam (IAPWS) Industrial Formulation 1997, known as the “IAPWSIF97” standard. http://www.iapws.org.

The spreadsheet calculator program running on the portable computer system performs a number of functions, namely: (i) importing the logged-in temperature, pressure and mass (or volume) flow rate data values; (ii) determining the input and output specific enthalpy values of water hᵢₙ and hₒᵤₜ using measured water temperatures and pressures Tᵢₙ, Pᵢₙ and Tₒᵤₜ, Pₒᵤₜ, respectively, and the integrated steam table for water; and (iii) for each measuring period, calculating the actual rate of heat energy transfer \dot{Q}_{ghe} being exchanged between the ground heat exchanging system and the deep Earth (at T_{de}) in units of [BTUs/Hr], using the enthalpy-based formula \dot{Q}_{ghe}=\dot{m}(hₒᵤₜ−hᵢₙ) derived hereinafter.

As will be shown in great detail hereinafter, this enthalpy-based formula for \dot{Q}_{ghe} is derived from mathematical modeling of the ground heat exchanging (GHE) system, through the application of the First Law of Thermodynamics based on energy and mass conservation and balancing principles, well known in the fields of thermodynamics and thermal and mass flow engineering.

Developing a Mathematical Model for the Ground Heat Exchanging (GHE) System and its Portable Enthalpy-Based Heat Transfer Rate (HTR) Test System in Accordance with Thermodynamic Energy and Mass Conservation Principles

The first step to designing and developing the enthalpy-based heat transfer rate test system and method of the present invention, involves developing a mathematical model for the ground heat exchanging (GHE) system which will be connected to the system during performance test operations. To build a thermodynamic model for the system, one must first define the system which, in general, can be any quantity of matter upon which attention is focused for study. In the present invention, the system will be identified as the water mass flowing through the ground heat exchanger installed in the deep Earth (de) environment. Everything external to the system shall be called the thermodynamic surroundings, and the system is separated from the surroundings by the system boundaries. The system boundaries may either be fixed or movable. In the present invention, there is a need to analyze the ground heat exchanger in thermodynamic terms, involving a flow of mass into and out of the underground heat exchanging device. The thermodynamic modeling process involves specifying a control surface or volume, such as the heat exchanger tube walls, and mass, as well as that heat energy that may flow across the control surface or volume, during system operation.

In the field of thermodynamics, systems are classified as isolated, closed, or open, based on the possible transfer of mass and energy across the system boundaries. A control volume is a fixed region in space chosen for the thermodynamic study of mass and energy balances for flowing systems. The boundary of the control volume may be a real or imaginary envelope. The control surface is the boundary of the control volume. An isolated system is one that is not influenced in any way by the surroundings. This means that no energy in the form of heat or work may cross the boundary of the system. In addition, no mass may cross the boundary of the system. A closed system has no transfer of mass with its surroundings, but may have a transfer of energy (either heat or work) with its surroundings. An open system is one that may have a transfer of both mass and energy with its surroundings (i.e. mass, heat, and external work are allowed to cross the control boundary).

When a system is in equilibrium with regard to all possible changes in state, the system is in thermodynamic equilibrium. Steady state is that circumstance in which there is no accumulation of mass or energy within the control volume, and the properties at any point within the system are independent of time. Whenever one or more of the properties of a system change, a change in the state of the system occurs. The path of the succession of states through which the system passes is called the thermodynamic process. One example of a thermodynamic process is increasing the temperature of a fluid while maintaining a constant pressure. Another example is increasing the pressure of a confined gas while maintaining a constant temperature. Thermodynamic processes occur in most thermodynamic systems, including geothermal ground heat exchangers.

In a thermodynamic system, energy is transferred and sometimes converted into other forms of energy, yet the sum of all energies must obey the First Law of Thermodynamics. As will be described in greater detail hereinafter, the various forms of energy that might be transferred in a system include potential energy (PE), kinetic energy (KE), internal energy (U), flow energy (P-V), work (\dot{W}) and heat (\dot{Q}). Such diverse forms of energy may be measured in numerous basic units. It will be helpful to concisely summarize such units of energy measurement.

In general, there are three types of units to measure energy: (1) mechanical units, such as the foot-pound-force (ft-lbf); (2) thermal units, such as the British thermal unit (Btu); and (3) electrical units, such as the watt-second (W-sec). In the mks (meter, kilogram and second) and cgs (centimeter, grams and second) systems, the mechanical units of energy are the joule (j) and the erg, the thermal units are the kilocalorie (kcal) and the calorie (cal), and the electrical units are the watt-second (W-sec) and the erg. Although the units of the various forms of energy are different, they are equivalent.

In 1843, J. P. Joule conducted some very important experiments in science demonstrating quantitatively that there was a direct correspondence between mechanical and thermal energy. These experiments showed that one kilocalorie equals 4,186 joules. These same experiments, when performed using English system units, show that one British thermal unit (Btu) equals 778.3 ft-lbf. These experiments established the equivalence of mechanical and thermal energy. Other experiments established the equivalence of electrical energy with both mechanical and thermal energy. For engineering applications, these equivalences are expressed by the following relationships:

1 ft-lbf=1.286×10−3 Btu=3.766×10⁻⁷ kW-hr

1 Btu=778.3 ft-lbf=2.928×10⁻⁴ kW-hr

1 kW-hr=3.413×10³ Btu=2.655×10⁶ ft-lbf

1 hp-hr=1.980×10⁶ ft-lbf

These relationships can be used to convert between the various English system units for the various forms of energy.

In an energy transfer system, most computations involving the energy of the working fluid are performed in unit of Btu's. Forms of mechanical energy (such as potential energy, kinetic energy, and mechanical work) and other forms of energy (such as P-V energy) are usually given in foot-pounds-force. These forms of mechanical energy are converted to Btu's by using the conversion factor 1 Btu=778.3 ft-lbf. From this conversion factor, the mechanical equivalent of heat, denoted by the symbol J and referred to as Joule's constant, is defined as J=778 ft lbf./Btu.

Power is defined as the time rate of doing work. It is equivalent to the rate of the energy transfer. Power has units of energy per unit time. As with energy, power may be measured in numerous basic units, but the units are equivalent. In the English system, the mechanical units of power are foot-pounds-force per second or per hour (ft-lbf/sec or ft-lbf/hr) and horsepower (hp). The thermal units of power are British thermal units per hour (Btu/hr), and the electrical units of power are watts (W) or kilowatts (kW). For engineering applications, the equivalence of these units is expressed by the following relationships.

1 ft-lbf/sec=4.6263 Btu/hr=1.356×10⁻³ kW

1 Btu/hr=0.2162 ft-lbf/sec=2.931×10⁻⁴ kW

1 kW=3.413×10³ Btu/hr=737.6 ft-lbf/sec

Horsepower is related to foot-pounds-force per second (ft-lbf/sec) by the following relationship: 1 hp=550.0 ft-lbf/sec. These relationships can be used to convert the English system units for power.

### Modeling the Energy and Mass Balances Across the Control Volume of the Ground Heat Exchanger and its Portable Enthalpy-Based Heat Transfer Rate (Htr) Test System

The First Law of Thermodynamics relates to the balance of the various forms of energy as such forms of energy pertain to the specified thermodynamic system under study. Specifically, the First Law of Thermodynamics states that energy can neither be created nor destroyed, but rather transformed into various forms as the fluid or mass flow within the control volume is being studied.

In engineering, energy balances are used to quantify the energy used or produced by a system. Making an energy balance for a system is similar to making a mass balance for the system, but there are a few differences to remember, namely: that a specific system might be closed in a mass balance sense, but open as far as the energy balance is concerned; and that while it is possible to have more than one mass balance for a system, there can be only one energy balance.

The First Law of Thermodynamics addresses the total amount of energy, which consists of kinetic energy (KE), potential energy (PE) known as mechanical energy, and the internal energy (U) including flow energy (Pv), represented by specific enthalpy h of the system. For any system, energy transfer is associated with (i) mass and energy crossing the control boundary, (ii) external work and/or heat crossing the boundary, and (iii) the change of stored energy within the control volume. In general, kinetic, potential, internal, “flow” energies and the exchange of external work and/or heat energy are associated with the flow of fluid mass in the system, and must be considered during the overall energy balance of the system. In the case of the present invention, the heat transfer fluid or mass flow is water, but may be any aqueous-based fluid, in general.

To perform an energy balance for a system in accordance with the First Law of Thermodynamics, the various energies associated with water are identified as they cross the boundaries of the system, and then mathematical expressions are drawn to the energy balance of the system under analysis.

The First Law of Thermodynamics can be expressed in different ways.

The First Law of Thermodynamics states that, in an open system, all energies flowing into a system are equal to all energies leaving the system, plus the change in storage of energies within the system.

When expressed over a time interval (Δₜ), the First Law of Thermodynamics states that the increase in the amount of energy stored in a control volume must equal the amount of energy that enters the control volume, minus the amount of energy that leaves the control volume. When applying this principle, it should be recognized that energy can enter and leave the control volume due to heat transfer (\dot{Q}) through the boundaries, work done on a by the control volume (\dot{W}), and energy advection. For the study of heat transfer, focus should be made on thermal and mechanical forms of energy. The sum of thermal and mechanical energy is not conserved because there can be conversion between other forms of energy and thermal energy. Energy conversion results in thermal energy generation, which can be either positive or negative.

When expressed as a thermal and mechanical energy balance equation over a time interval (Δₜ), the First Law of Thermodynamics states that the increase in the amount of thermal and mechanical energy stored in the control volume must equal the amount of thermal and mechanical energy that enters the control volume, minus the amount of thermal and mechanical energy that leaves the control volume, plus the amount of thermal energy that is generated within the control volume.

As the First Law of Thermodynamics must be satisfied at each and every instant of time t, it can be formulated on as rate basis as follows: the rate of increase of thermal and mechanical energy stored in the control volume must equal the rate at which thermal and mechanical energy enters the control volume, minus the rate at which thermal and mechanical energy leaves the control volume, plus the rate at which thermal energy is generated within the control volume.

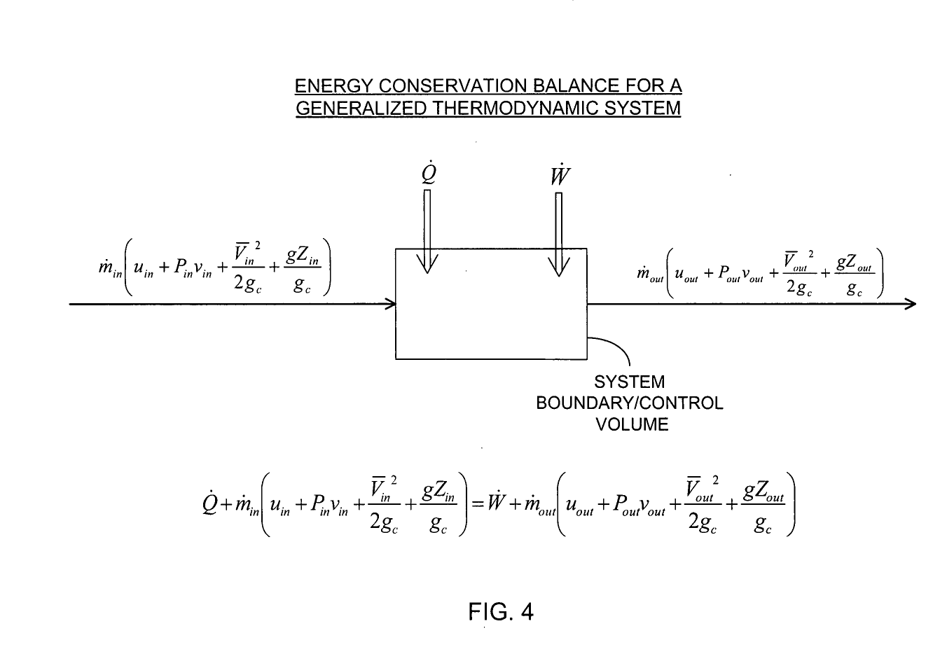

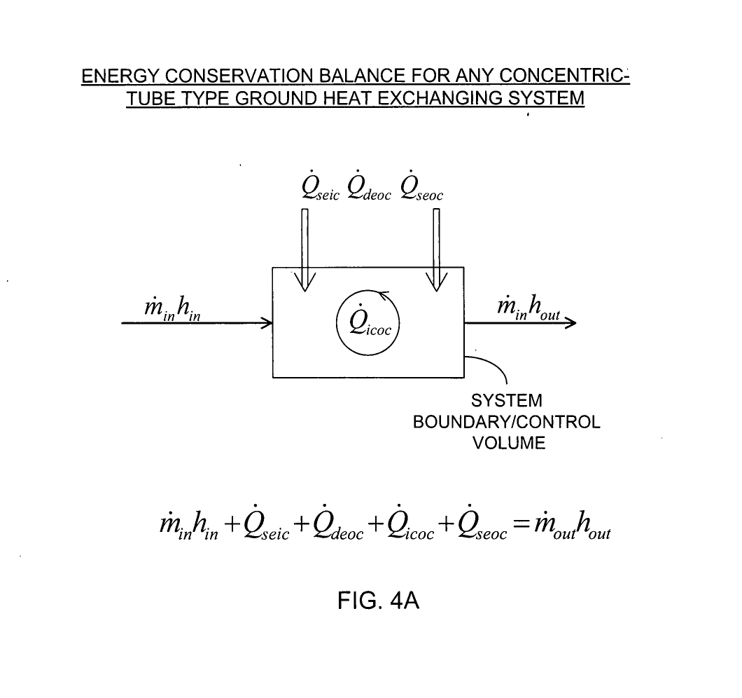

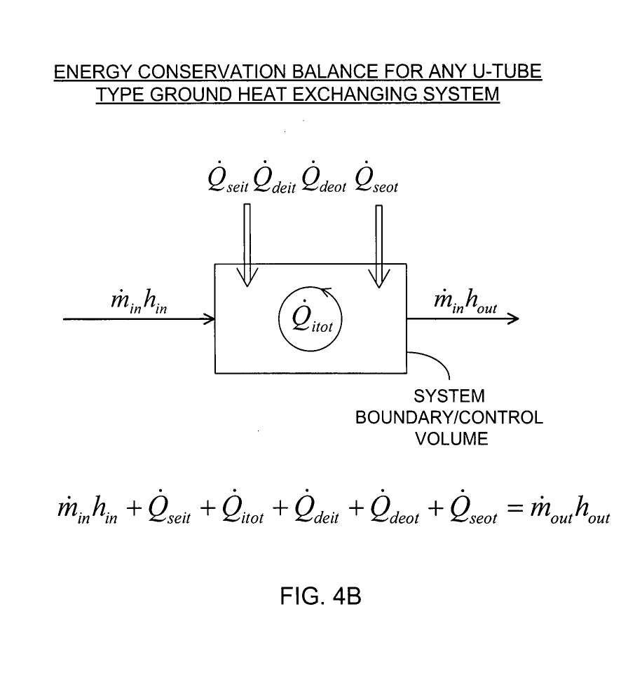

Thus, for any closed thermodynamic system, in which the rate of increase of thermal and mechanical energy stored in its control volume is zero, the First Law of Thermodynamics can be expressed in rate form as a generalized energy conservation balance, shown in FIG. 4 and given by the expression below:

$$\dot{Q} + {\dot{m}}_{in} ( {u}_{in} + {P}_{in} {v}_{in} + \frac{{\overline{V}}_{in}^{2}}{2 {g}_{c}} + \frac{{gZ}_{in}}{{g}_{c}} ) = \dot{W} + {\dot{m}}_{out} ( {u}_{out} + {P}_{out} {v}_{out} + \frac{{\overline{V}}_{out}^{2}}{2 {g}_{c}} + \frac{{gZ}_{out}}{{g}_{c}} )$$

where:
\dot{Q}=represents (all) heat flow rates into the system (Btu/hr)
\dot{m}ᵢₙ=mass flow rate into the system (lbm/hr)
uᵢₙ=specific internal energy into the system (Btu/lbm)
Pᵢₙvᵢₙ=pressure-specific volume energy into the system (ft-lbf/lbm)
vᵢₙ=specific volume of fluid entering the system (ft³/lbm)
Pᵢₙ=pressure of fluid into the system (ft-lbf/ft²)
V̅ᵢₙ²/2g_{c}=KEᵢₙ=kinetic energy into the system (ft-lbf/lbm)
where
V̅ᵢₙ=average velocity of fluid into the system (ft/sec)
g_{c}=the gravitational constant (32.17 ft-lbm/lbf-sec²)
g Zᵢₙ/g_{c}=PEᵢₙ=potential energy of the fluid entering the system (ft-lbf/lbm)
where
Zᵢₙ=height above reference level (ft) (at the surface of the Earth)
g=acceleration due to gravity (ft/sec²)
g_{c}=the gravitational constant (32.17 ft-lbm/lbf-sec²)
\dot{W}=(all) work flow rate out of the system (ft-lbf/hr)
\dot{m}ₒᵤₜ=mass flow rate out of the system (lbm/hr)
uₒᵤₜ=specific internal energy out of the system (Btu/lbm)
Pₒᵤₜvₒᵤₜ=pressure-specific volume energy out of the system (ft-lbf/lbm)
vₒᵤₜ=specific volume of fluid leaving the system (ft³/lbm)
Pₒᵤₜ=pressure of fluid out of the system (ft-lbf/ft²)
V̅ₒᵤₜ²/2g_{c}=KEₒᵤₜ=kinetic energy out the system (ft-lbf/lbm)
wherein
V̅ₒᵤₜ=average velocity of fluid into the system (ft/sec)
g Zₒᵤₜ/g_{c}=PEₒᵤₜ=potential energy out of the system (ft-lbf/lbm)
Zₒᵤₜ=height above reference level (ft) (at the surface of the Earth)

To determine which of these energy component terms are present in a ground heat exchanger of the type shown in FIGS. 1A through 2B, and should be considered in any heat transfer model, it will be helpful to briefly review the nature and properties of each of these energy components in the general model, and then develop particular energy balance models for the ground heat exchangers shown in FIGS. 1A, 1B and 2A, 2B.

### Potential Energy (PE)

Potential energy (PE) is defined as the energy of position. Using English system units, it is defined by PE=mgZ/g_{c}

where
PE=potential energy (ft-lbf)
m=mass (lbm)
Z=height above some reference level (ft)
g=acceleration due to gravity (ft/sec²)
g_{c}=gravitational constant=32.17 ft-lbm/lbf-sec²

### Kinetic Energy (KE)

Kinetic energy (KE) is the energy of motion. Using English system units, it is defined by

KE=m V̅²/2g_{c}

where:
KE=kinetic energy (ft-lbf)
m=mass (lbm)
V̅=velocity (ft/sec)
g_{c}=gravitational constant=32.17 ft-lbm/lbf-sec²

### Specific Internal Energy (U)

Potential energy and kinetic energy are macroscopic forms of energy. They can be visualized in terms of the position and the velocity of objects. In addition to these macroscopic forms of energy, a substance, such a flow of mass or fluid, possesses several microscopic forms of energy. Microscopic forms of energy include those due to the rotation, vibration, translation, and interactions among the molecules of a substance. While none of these forms of energy can be measured or evaluated directly, techniques have been developed to evaluate the change in the total sum of all these microscopic forms of energy. These microscopic forms of energy are collectively called internal energy, customarily represented by the symbol U. In engineering applications, the unit of internal energy is the British thermal unit (Btu), which is also the unit of heat.

The specific internal energy (u) of a substance is its internal energy per unit mass. It equals the total internal energy (U) divided by the total mass (m).

u=U/m

where:
u=specific internal energy (Btu/lbm)
U=internal energy (Btu)
m=mass (lbm)

### Specific P-V Energy

In addition to the internal energy (U), another form of energy, called P-V energy, arises from the pressure (P) and the volume (V) of a fluid. It is numerically equal to PV, the product of pressure and volume. Because energy is defined as the capacity of a system to perform work, a system where pressure and volume are permitted to expand performs work on its surroundings. Therefore, a fluid under pressure has the capacity to perform work. In engineering applications, the units of P-V energy, also called flow energy, are the units of pressure multiplied by volume (pounds-force per square foot times cubic feet) which equals foot-pounds force (ft-lbf). The specific P-V energy of a substance is the P-V energy per unit mass. It equals the total P-V divided by the total mass m, or the product of the pressure P and the specific volume v, and is written as Pv.

Pv=PV/m

where:
P=pressure (lbf/ft2)
V=volume (ft3)
v=specific volume (ft3/lbm)
m=mass (lbm)

### Specific Enthalpy (h)

Specific enthalpy (h) is defined as h=u+Pv, where u is the specific internal energy (Btu/lbm) of the system being studied, P is the pressure of the system (lbf/ft²), and v is the specific volume (ft³/lbm) of the system. Enthalpy is a thermodynamic property of a substance, like pressure, temperature, and volume, but it cannot be measured directly. Normally, the enthalpy of a substance is given with respect to some reference value. For example, the specific enthalpy of water or steam is given using the reference that the specific enthalpy of water is zero at 0.01° C. and normal atmospheric pressure. The fact that the absolute value of specific enthalpy is unknown is not a problem, however, because it is the change in specific enthalpy (Δh) and not the absolute value that is important in practical problems. Steam tables include values of specific enthalpy as part of the information tabulated, and the specific enthalpy of water, h=f(p,T) is defined as a function of temperature and pressure, in accordance with the International Association for the Properties of Water and Steam (IAPWS) Industrial Formulation 1997, known as the “IAPWSIF97” standard.

### Work (W)

Kinetic energy, potential energy, internal energy, and P-V energy are forms of energy that are properties of a system. Work is a form of energy, but it is energy in transit. Work is not a property of a system. Work is a process done by or on a system, but a system contains no work. Work is defined for mechanical systems as the action of a force on an object through a distance. It equals the product of the force (F) times the displacement (d).

W=Fd

where:
W=work (ft-lbf)
F=force (lbf)
d=displacement (ft)
The rate at which Work is performed on or by a system is defined as Work Rate, \dot{W}, and is the time derivative of Work, W.

### Heat (Q)

Heat, like work, is energy in transit. The transfer of energy as heat, however, occurs at the molecular level as a result of a temperature difference. The symbol Q is used to denote heat. This should not be confused with the symbol \dot{Q} used to denote heat transfer rate, which the rate at which is transferred over time, the first time derivative of Q. In engineering applications, the unit of heat is the British thermal unit (Btu). Specifically, this is called the 60 degree Btu because it is measured by a one degree temperature change from 59.5 to 60.5° F.

As with work, the amount of heat transferred depends upon the path, and not simply on the initial and final conditions of the system. Also, as with work, it is important to distinguish between heat added to a system from its surroundings and heat removed from a system to its surroundings. A positive value for heat indicates that heat is added to the system by its surroundings. This is in contrast to work that is positive when energy is transferred from the system and negative when transferred to the system. The symbol q is sometimes used to indicate the heat added to or removed from a system per unit mass. The symbol q equals the total heat (Q) added or removed divided by the mass (m). The term “specific heat” is not used for q since specific heat is used for another parameter. The quantity represented by q is referred to simply as the heat transferred per unit mass.

q=Q/m

where:
q=heat transferred per unit mass (Btu/lbm)
Q=heat transferred (Btu)
m=mass (lbm)
Defining a Control Volume for the Ground Heat Exchanging System to be Tested Using the Test System and Method of the Present Invention, and then Constructing an Energy Balance Equation According to the First Law of Thermodynamics

The control volume approach will be used to analyze the ground heat exchangers of FIGS. 1A through 2B, and then constructing an energy balance for each system. In the control volume approach, a fixed region in space is established with specified control boundaries. The energies that cross the boundary of this control volume, including those with the mass crossing the boundary, are then studied and the energy balance performed.

As shown in FIG. 4A, the control volume of the concentric-tube ground heat exchanger system in FIG. 1A, 1B can be defined as the surfaces coincident with the inner and outer surfaces of the inner tube section of the concentric-tube ground heat exchanger, the inner surfaces of the outer tube sections, and the inner surfaces of the inlet and outlet ports of the header/distributor of the ground heat exchanger, connecting with the inner and outer tube sections.

In general, the forms of energy that may cross the control volume boundary include those associated with the mass (m) crossing the boundary. Mass in motion has potential (PE), kinetic (KE), and internal energy (U). In addition, since the mass flow is normally supplied with some driving power (e.g. a pump), there is another form of energy associated with the fluid caused by its pressure, referred to as flow energy (i.e. Pv-work). The thermodynamic terms thus representing the various forms of energy crossing the control boundary with the mass are given as \dot{m} (u+Pv+KE+PE).

In open and closed system analysis, the u and Pv terms occur so frequently that another property, specific enthalpy, has been defined as h=u+Pv, and has been discussed in detail above. This results in the above expression being written as \dot{m} (h+KE+PE). In addition to the mass and its energies, externally applied work (W), usually designated as shaft work, is another form of energy that may cross the system boundary. To complete and satisfy the conservation of energy relationship, energy that is caused by neither mass nor shaft work, is classified as heat energy (\dot{Q}). These relationships can be used to reformulate the Eulerian energy conservation equation as follows:

\dot{m}(hₒᵤₜ+PEₒᵤₜ+KEₒᵤₜ)=\dot{m}(hᵢₙ+PEᵢₙ+KEᵢₙ)+\dot{Q}+\dot{W}

where:
\dot{m}=mass flow rate of working fluid into and out of the system (lbm/hr)
hᵢₙ=specific enthalpy of the working fluid entering the system (Btu/lbm)
hₒᵤₜ=specific enthalpy of the working fluid leaving the system (Btu/lbm)
PEᵢₙ=specific potential energy of working fluid entering the system (ft-lbf/lbm)
PEₒᵤₜ=specific potential energy of working fluid leaving the system (ft-lbf/lbm)
KEᵢₙ=specific kinetic energy of working fluid entering the system (ft-lbf/lbm)
KEₒᵤₜ=specific kinetic energy of working fluid leaving the system (ft-lbf/lbm)

\dot{W}=rate of work done by the system (ft-lbf/hr)

\dot{Q}=heat transfer rate into the system (Btu/hr)

When the thermodynamic system (e.g. heat transferring fluid being studied) changes its properties (i.e. temperature, pressure, volume) from one value to another as a consequence of work or heat or internal energy exchange, then it is said that the fluid has gone through a “process.” In some processes, the relationships between pressure, temperature, and volume are specified as the fluid goes from one thermodynamic state to another. The most common processes are those in which the temperature, pressure, or volume is held constant during the process. These would be classified as isothermal, isobaric, or isovolumetric processes, respectively. If the fluid passes through various processes and then eventually returns to the same state it began with, then the system is said to have undergone a cyclic process.

In the geothermal ground heat exchanging systems under consideration, the potential and kinetic energy terms PE and KE and work rate term W are recognized as being negligible and thus considered zero, and the mass flow rate entering the system equals the mass flow rate leaving the system \dot{m}₁=\dot{m}₂=\dot{m}, greatly simplifying the energy balance equation for each ground heat exchanging system, as follows:

\dot{m}hₒᵤₜ=\dot{m}hᵢₙ+\dot{Q}

With algebraic manipulation, the energy balance equation can be expressed as:

\dot{Q}=\dot{m}(hₒᵤₜ+hᵢₙ)

At this stage, it is helpful to recognize the different heat transfer rate components operating within each type of ground heat exchanging system, however small or negligible they may be, and thereafter decide to eliminate particular such terms from the model based on rational analysis, consistent with observable facts.

Referring to FIG. 4A, potential heat transfer rate terms associated with a concentric-tube type ground heat exchanger are identified as: \dot{Q}_{seic} \dot{Q}_{icoc} \dot{Q}_{icoc} \dot{Q}_{seoc}, where each specified heat flow term is identified and graphically illustrated in the model of FIG. 4A.

Notably, the terms \dot{Q}_{seic} and \dot{Q}_{seoc} will be negligible in concentric-tube ground heat exchanging systems constructed using HPDE header/distributor components and HDPE piping between ground heat exchangers, because HDPE plastic has an extremely low thermal conductivity (i.e. high thermal resistivity). Also, the cross flow channel heat transfer term \dot{Q}_{icoc} will be negligible when concentric-tube ground heat exchanging systems employ PVC inner tubes and supports laminar flows along the inner flow channel, as taught in U.S. Pat. No. 7,343,753, supra, incorporated herein by reference. This is because PVC has an extremely low thermal conductivity (i.e. high thermal resistivity) and laminar flow along the inner flow channel (oc) of the inner tube of the concentric-tube ground heat exchanger will create sufficient thermal boundary layers, and establish very low heat transfer coefficients for convective and conductive forms of heat flow, from the inner flow channel to the outer flow channel (via the inner tube wall). Based on such rational analysis, the energy balance equation for the concentric-tube ground heat exchangers employing laminar and turbulence flows, as taught in U.S. Pat. No. 7,343,753, reduces to the following expression:

\dot{Q}_{deoc}=\dot{m}(hₒᵤₜ+hᵢₙ)

By definition, the heat transfer rate for the concentric-tube ground heat exchanger can be then defined as \dot{Q}_{ghe} and provided by the following equation:

\dot{Q}_{ghe}=\dot{m}(hₒᵤₜ+hᵢₙ)

This enthalpy-based heat transfer rate formula will hold for values of mass flow rates, and entering and leaving temperatures and pressures for which the U-tube ground heat exchanger has been designed to operate. Also this enthalpy-based heat transfer rate equation will be used in the method of heat transfer rate testing illustrated in FIGS. 7A through 7C when testing the heat transfer rate performance of any concentric-tube ground heat exchanger in accordance with the principles of the present invention.

Referring to FIG. 4B, the potential heat transfer rate terms associated with a U-Tube type ground heat exchanger include: \dot{Q}ₛₑᵢₜ \dot{Q}ᵢₜₒₜ \dot{Q}_{deit} \dot{Q}_{deot} \dot{Q}ₛₑₒₜ where each specified heat flow term is identified and graphically illustrated in the model of FIG. 4B.

Notably, the terms \dot{Q}ₛₑᵢₜ and \dot{Q}ₛₑₒₜ will be negligible in U-tube type ground heat exchanging systems constructed using HDPE piping between ground heat exchangers, because HDPE plastic has an extremely low thermal conductivity (i.e high thermal resistivity). However, the cross tube heat transfer term \dot{Q}ᵢₜₒₜ will not be negligible when U-tube ground heat exchanging systems employ HDPE and thermally conductive grouting, resulting in thermal short-circuiting and reduction in efficiency of the U-tube ground heat exchanger. This is because typically the temperature gradient between the HDPE inlet tube (it) and the HPDE outlet tube (ot) will not insignificant due to the relatively close spacing between these tubes and the presence of thermally-conductive grouting disposed therebetween. In effect, such thermal short-circuiting caused by heat transfer rate \dot{Q}ᵢₜₒₜ will reduce the net effect of positive heat transfer rates \dot{Q}_{deit} and \dot{Q}_{deot} supported between the deep Earth (at temperature T_{de}) and the inlet tube (it) and outlet tube (ot) of any U-tube ground heat exchanger construction, and can be considered a net heat transfer rate between the U-tube ground heat exchanger and the deep Earth, represented by the net heat transfer rate term \dot{Q}_{ghe}=\dot{Q}_{deit}+\dot{Q}_{deot}+\dot{Q}ᵢₜₒₜ. Based on such rational analysis, the energy balance equation for the U-tube ground heat exchanger also reduces to the following expression:

\dot{Q}_{ghe}=\dot{m}(hₒᵤₜ+hᵢₙ)

This enthalpy-based heat transfer rate formula will hold for values of mass flow rates, and entering and leaving temperatures and pressures for which the U-tube ground heat exchanger has been designed to operate. This same heat transfer rate equation will be also used in the method of heat transfer rate testing illustrated in FIGS. 7A through 7C when testing the performance of any U-tube type ground heat exchanger, or other type of geothermal ground heat exchanger, in accordance with the principles of the present invention.
Defining the Control Volume for the Portable Enthalpy-Based Heat Transfer Rate Test System of the Present Invention, and then Constructing an Energy Balance Equation According to the First Law of Thermodynamics

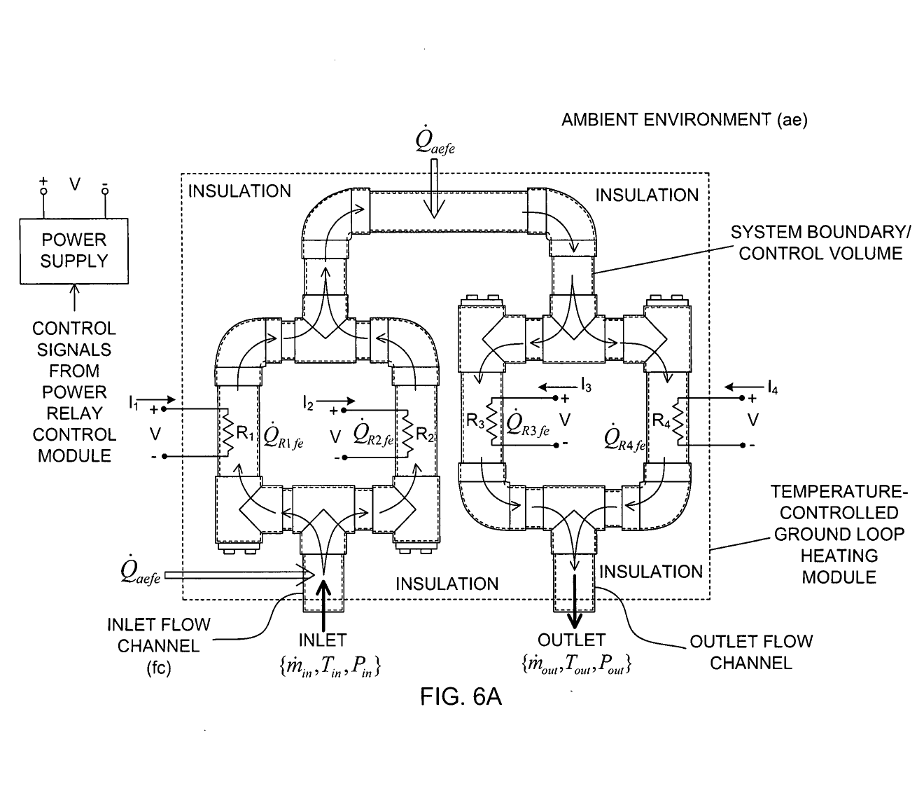

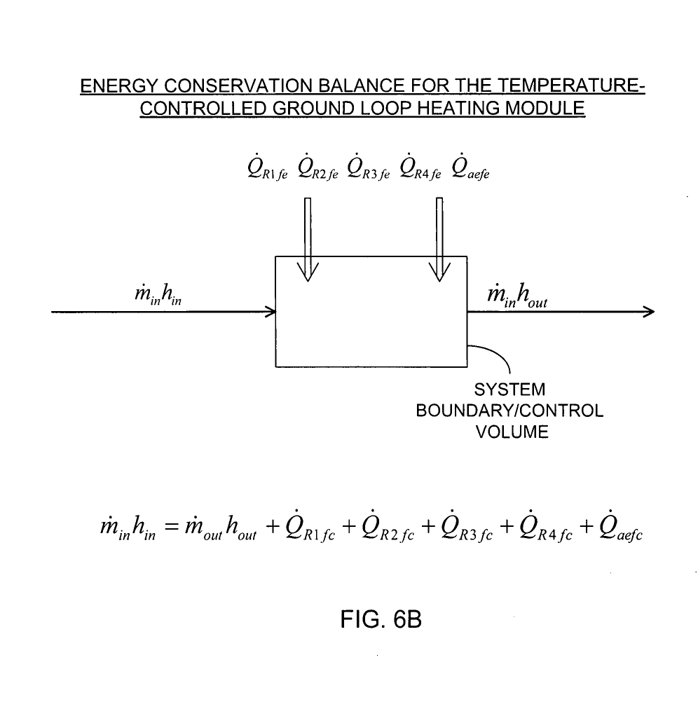

The control volume approach will be used to analyze the portable enthalpy-based heat transfer rate test system of FIG. 6, and then an energy balance equation will be derived for the system. From the energy balance equation, a heat transfer rate equation will be derived which describe the rate of heat energy which will need to be generated by the electrically-driven heating elements R₁ through R₄, supplied with electrical power supplies P₁ through P₄, respectively, so that the temperature state of the water entering the ground heat exchanger will remain substantially constant during the long-term HTR performance testing operations in a ground loop field test site.

As shown in FIG. 6, the control volume of the HTR test system are defined as the surfaces coincident with the outer surfaces of flow tube sections of ground loop heating module, which are surrounded by thermal insulation material to minimize heat transfers between the flow channels and the ambient environment (ae). Along these flow channels (fe), the four heating elements are mounted so that water flows thereabout at a constant mass flow rate \dot{m}ₒᵤₜ=\dot{m}ᵢₙ controlled by the pair of water pumps provided in the HTR test system.

As illustrated in FIG. 6, the state properties of water returning from the ground loop heat exchanger, and entering the temperature-controlled ground loop water heating module, are defined by {\dot{m}ₒᵤₜ,Tₒᵤₜ,Pₒᵤₜ,hₒᵤₜ} whereas the state properties of water exiting the water heating module and entering the ground heat exchanger under testing, are defined by {\dot{m}ᵢₙ,Tᵢₙ,Pᵢₙ,hᵢₙ}.

Applying the rate form of the First Law of Thermodynamics to the control volume of this system, results in the following energy balance equation:

\dot{m}ᵢₙhᵢₙ=\dot{m}ₒᵤₜhₒᵤₜ+\dot{Q}_{R1fc}+\dot{Q}_{R2fc}+\dot{Q}_{R3fc}+\dot{Q}_{R4fc}+\dot{Q}_{aefc}

The heat transfer flow rate from the ambient environment to the flow channels of the water heating apparatus, \dot{Q}_{aefc}, will be negligible when packing the tubes of the apparatus in thermal insulation, as specified in FIG. 6.A. Also, the heat generation rates for each of the four heating elements along the flow channels of the water heating module, are denoted by \dot{Q}_{R1fc} \dot{Q}_{R2fc} \dot{Q}_{R3fc} \dot{Q}_{R4fc}, respectively.

Through excellent heat convection design, and material science, very high energy conversion rates can be achieved, to efficiently introduce heat energy into the constant mass flow of the system (across its control volume), according to the following electrical-thermal energy conversion formulas:

$$\begin{matrix}{P}_{1} = {VI}_{1} = \frac{{V}^{2}}{{R}_{1}} = {\dot{Q}}_{R 1 fc} & {P}_{2} = {VI}_{2} = \frac{{V}^{2}}{{R}_{2}} = {\dot{Q}}_{R 2 fc} \\ {P}_{3} = {VI}_{3} = \frac{{V}^{2}}{{R}_{3}} = {\dot{Q}}_{R 3 fc} & {P}_{4} = {VI}_{4} = \frac{{V}^{2}}{{R}_{4}} = {\dot{Q}}_{R 4 fc}\end{matrix}$$

wherein total power supplied to the water heating elements P1, P2, P3, and P4 is equal to the total power supplied to the water heating module, providing the equation P_{Heater}=VI₁+VI₂+VI₃+VI₄, where V is a constant voltage supplied across each heating element, and electrical currents I₁, I₂, I₃ and I₄ flow through heating elements R₁, R₂, R₃ and R₄, respectively. The sum of the four heat generation processes \dot{Q}_{R1fc} \dot{Q}_{R2fc} \dot{Q}_{R3fc} \dot{Q}_{R4fc} can be denoted as \dot{Q}ₕₑₐₜₑᵣ and the energy balance equation be expressed as: \dot{m}ᵢₙhᵢₙ=\dot{m}ₒᵤₜhₒᵤₜ+\dot{Q}ₕₑₐₜₑᵣ

Using the relation \dot{m}₁=\dot{m}₂=\dot{m}, the energy balance equation for the water heating module can be expressed as:

\dot{Q}ₕₑₐₜₑᵣ=\dot{m}(hᵢₙ−hₒᵤₜ)

wherein the leaving water temperature T₁ will be greater than the entering water temperature T₂ into the water heating module, and thus making hᵢₙ>hₒᵤₜ a positive value, indicating that the direction of heat rate transfer will be from the heating elements into the water flow, during ground heat exchanger testing operations.

Using these relationships, the energy conservation balance for the temperature-controlled ground loop heating module can be reduced to the expression:

\dot{Q}ₕₑₐₜₑᵣ=−\dot{m}(hₒᵤₜ+hᵢₙ)

and recognizing that \dot{Q}_{ghe}=\dot{m}(hₒᵤₜ+hᵢₙ), a simple energy balance equation can be formulated as follows:

\dot{m}\dot{Q}ₕₑₐₜₑᵣ=−\dot{Q}_{ghe}

Notably, this energy balance equation states that, during ground heat exchanger test operations, when the heat transfer rate test system is operating in its cooling mode where Tᵢₙ>Tₒᵤₜ>T_{de}, heat energy \dot{Q}ₕₑₐₜₑᵣ is introduced into the constant water (mass) flow (i.e. control volume) by the water heating module while heat energy −\dot{Q}_{ghe} moves away from the heated water in the ground heat exchanger (i.e. control volume) and into the deep Earth, in accordance with the First Law of Thermodynamics, and consistent with design specifications for the heat transfer rate test system of the present invention.

For further details regarding thermodynamics, heat transfer and fluid and mass flow principles related to the present invention, reference is made to: DOE Fundamentals Handbook: Thermodynamics, Heat Transfer, And Fluid Flow, Volumes 1, 2 and 3, DOE-HDBK-1012/1-92, June 1992, DOE-HDBK-1012/2-92, June 1992 and DOE-HDBK-1012/3-92, June 1992; Fundamentals of Heat and Mass Transfer (Sixth Edition) 2007 by F. P. Incropera, D. P. Dewitt, T. L. Bergmann, and A. S. Lavine, John Wiley & Sons; and A Heat Transfer Textbook (Third Edition) 2008 by John H. Lienhard IV and John H. Lienhard V, Phlogiston Press, Cambridge Mass.; wherein each said reference is incorporated herein by reference.

### Method of Measuring the Heat Transfer Rate Capacity of a Ground Heat Exchanging System

Based on thermodynamic and energy and mass conservation principle, the mathematical formula \dot{Q}_{ghe}=\dot{m}(hₒᵤₜ+hᵢₙ) has been derived above for calculating the heat transfer rate between the ground heat exchanger (GHE) under testing and its deep Earth environment, \dot{Q}_{ghe}=\dot{Q}_{deoc}, given measured values of input and output temperatures and pressures, and mass flow rates across the ground heat exchanger.

It is now appropriate at this juncture, to describe a novel method of measuring the heat transfer rate capacity of a ground heat exchanging system, illustrated in FIGS. 7A through 7C, and involving the use of this enthalpy-based heat transfer rate (HTR) formula.

As indicated in FIG. 7A, Step 1 of the HTR test method involves installing, or have installed, a ground heat exchanger (GHE) in a borehole drilled in the Earth at a location where a ground loop subsystem is to be designed and constructed using multiple such ground heat exchangers.

Step 2 of the HTR test method involves connecting the portable heat transfer rate testing system to the input and output ports of the installed ground heat exchanger, and charging the resulting ground loop with a predetermined fixed quantity of water (i.e. heat transferring fluid) with an inlet water pressure Pᵢₙ=20 [psig].

Step 3 of the HTR test method involves starting the water circulation pump and circulating the predetermined quantity of water through the test loop at a constant mass flow rate in [lbm/hr] through the test ground loop.

Step 4 of the HTR test method involves starting to monitor and logging-into the data logger/recorder, the controlled mass flow rate of water \dot{m}, as well as the inlet and outlet/return water temperatures Tᵢₙ and Tₒᵤₜ measured in units of [° F.], and inlet and outlet/return water pressures Pᵢₙ and Pₒᵤₜ measured in units of [° F.].

Step 5 of the HTR test method involves monitoring the loop water temperatures Tᵢₙ and Tₒᵤₜ and determine when these temperatures are approximately equal Tₒᵤₜ=Tᵢₙ which will be deemed a steady-state value approximating the deep Earth temperature T_{de}=Tₒᵤₜ=Tᵢₙ, which typically will fall within the range of about 45° F. to about 75° F. depending on the borehole location in the planet Earth.

Notably, Steps 3 through 5 provide a way to estimate the time-response characteristics of the ground heat exchanger to store up thermal energy in the mass of its heat transfer fluid (e.g. water), physical structure and surrounding borehole Earth environment, for subsequent release to the geothermal system (e.g. ground source heat pump) during heating modes of operation.

Step 6 of the HTR test method involves, when T_{de}=Tₒᵤₜ=Tᵢₙ, starting the electrically-powered water heaters and beginning to introduce thermal energy into the water being controllably circulated through the test ground loop.

Step 7 of the HTR method involves determining when the temperature of water flowing into the inlet of the ground heat exchanger T₁ reaches a constant input temperature Tᵢₙ (e.g. Tᵢₙ=95° F. in the Cooling Test Mode) maintained by the electrical water heater and its control circuitry, and when this condition is detected, then sending a start test command to the data logger/recorder to begin a predetermined test period (e.g. 72 hours) and start indexing recorded test data as being part of the test data set.

Step 8 of the HTR method involves automatically measuring, logging and recording within the digital recorder/logger, temperatures Tᵢₙ and Tₒᵤₜ, pressures Pᵢₙ and Pₒᵤₜ, and the constant mass flow rate of water \dot{m} [lbm/hr] or its volume flow rate F [gallons/minute], at discrete periodic sampling times (e.g. every 60 seconds), during the entire test period.

Step 9 of the HTR method involves using a programmed enthalpy-based spreadsheet heat transfer rate (HTR) calculator, as illustrated in FIG. 9, with integrated steam tables for sub-cooled water over the range of measured temperature and pressures values, to perform the following operations, during or at the end of the test period:

(i) importing logged-in temperature, pressure and mass flow rate data values into the spreadsheet heat transfer rate (HTR) calculator;

(ii) using measured water temperatures and pressures Tᵢₙ, Pᵢₙ and Tₒᵤₜ, Pₒᵤₜ, respectively, and the steam tables for water, to determine the input and output enthalpy values of water in the ground loop, hᵢₙ and hₒᵤₜ, expressed in units of [BTUs/lbm];

(iii) for each measuring period, using the enthalpy-based heat transfer rate formula: Q_{ghe}=\dot{m} (hₒᵤₜ−hᵢₙ) and Enthalpy Chart illustrated in FIG. 8 to calculate the actual rate of heat energy transfer Q_{ghe} being exchanged between the ground heat exchanger and its deep Earth environment, measured in units of [BTUs/Hr]; and

(iv) entering computed the heat transfer rate values Q_{ghe} into the programmed spreadsheet calculator.

Step 10 of the HTR method involves determining when the last measuring period in the predetermined time period of the performance test has lapsed, and when this even has been detected, then stopping the electrically-powered water heaters from supplying heat energy into the circulating water loop but continuing the pumping of water through the loop at constant mass flow rate \dot{m}, while measuring and logging-into the data logger/recorder, the controlled mass flow rate of water \dot{m}, the inlet and outlet/return water temperatures Tᵢₙ and Tₒᵤₜ, and inlet and outlet/return water pressures Pᵢₙ and Pₒᵤₜ.

Step 11 of the HTR method involves monitoring the loop water temperatures Tᵢₙ and Tₒᵤₜ and determining when these temperatures are approximately equal Tₒᵤₜ=Tᵢₙ which will be deemed a steady-state value approximating the deep Earth temperature T_{de}=Tₒᵤₜ=Tᵢₙ.

Step 12 of the HTR method involves determining when T_{de}=Tₒᵤₜ=Tᵢₙ, and when this condition is detected, stopping the water loop pumps, and concluding that the performance test has been completed.

Step 13 of the HTR method involves generating a heat transfer rate performance chart for the completed performance test period, indicating the actual heat transfer rates Q_{ghe} supported by the ground heat exchanger under performance testing.

Steps 10 through 13 provide a way to estimate the time-response characteristics of the ground heat exchanger during the release thermal energy stored up in the mass of its heat transfer fluid (e.g. water), physical structure and surrounding borehole Earth environment, to the geothermal system (e.g. ground source heat pump) during heating modes of operation.

Such in situ heat transfer rate measurements on a test ground heat exchanger installation provides the ground loop designer and engineer with an empirical measure on the rate of heat energy (expressed in BTU/Hour) that a single installed ground heat exchanger of a particular borehole length can be expected to actually transfer (i.e. exchange) between the Earth and the geothermal heat pump or chiller system to which the ground heat exchanger is connected, where such in situ heat transfer rate testing is performed.

Also, performing in situ heat transfer rate measurements on a test ground heat exchanger installation as described above provides the ground loop designer and engineer with an empirical measure on the rate of heat energy that a linear foot of ground heat exchanger can be expected to actually transfer (i.e. exchange) between the Earth, expressed in units of [BTU/hr ft].

### Measuring the Heat Transfer Rate Between Neighboring Ground Heat Exchangers Using the System and Method of the Present Invention

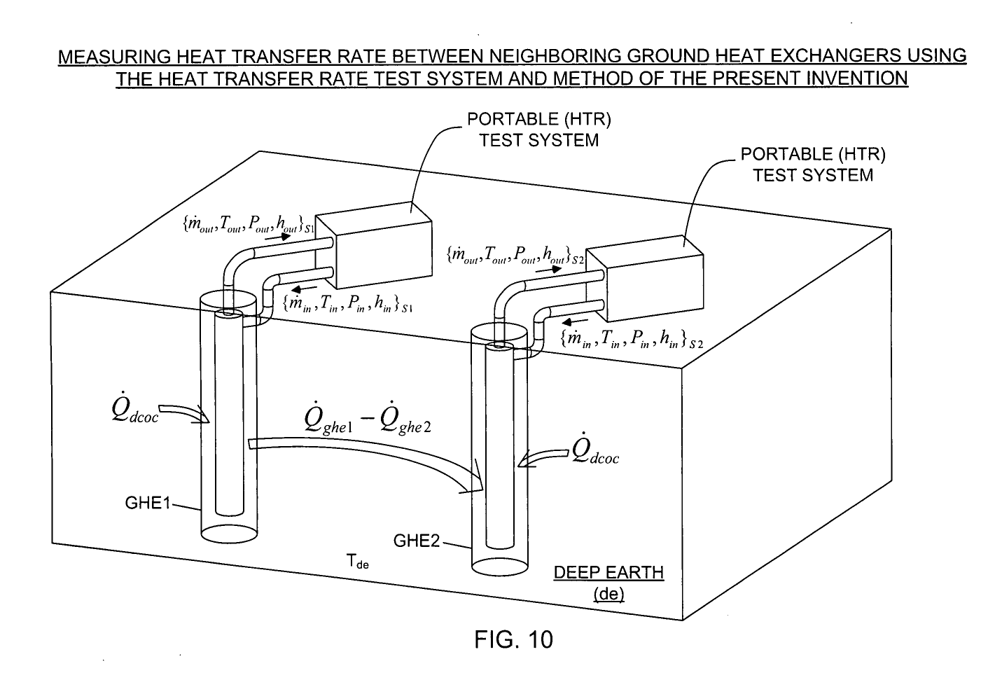

Referring to FIG. 10, there is provided apparatus and a method for measuring the heat transfer rate between a two or more neighboring ground heat exchangers installed in boreholes drilled at predetermined distance apart (e.g. 20 feet between neighboring borehole centerlines) at a particular test site where a ground loop under design has been planned for construction. This test method is different from the test method illustrated in FIGS. 7A through 7C, provides a measure on the rate of heat transfer between two neighboring ground heat exchangers installed in relatively close proximity. As shown in FIG. 10, the first ground heat exchanger is connected to a first portable heat transfer rate test system (S1) and operating with its ground loop water heating module being actively powered with all data monitoring, logging and recording functions working during the entire 72 hour test period. The second ground heat exchanger is connected to a second portable heat transfer rate test system (S2) with its ground loop water heating module de-activated (i.e. not powered) but with all data monitoring, logging and recording functions working during the entire 72 hour test period of the first HTR test system (S1).

In Earth environments where there is sufficient ground water and adequate thermal conductivity characteristics between the two ground heat exchangers, the measured value of heat transfer rate \dot{Q}_{gheS1-gheS2} at the second ground heat exchanger GHE-S2 should be relative low, if not negligible, during steady-state long term conditions.

By installing a third and possibly a fourth ground heat exchanger at borehole spacing of 15 feet and 25 feet, or at distance values about the selected 20 feet distance, comparative tests can be made to empirically measure the heat transfer characteristics of the deep Earth environment, and how such characteristics impact the heat energy coupling between neighboring ground loop heat exchanger installations, at particular test sites.

### Overview on Methods of Designing and Constructing Ground Loops According to Principles of the Present Invention

Using the ground loop design and construction method of the present invention, the ground loop designer or engineer works with average heat transfer rates (HTR) that have been empirically determined by the ground heat exchanger (GHE) manufacturer/supplier, and/or its geothermal consulting team, for a particular model of concentric-tube type ground heat exchanging system (assumed of 300 foot linear length) when installed in diverse kinds of geological environments and conditions but generally characterized by the presence of low to moderate levels of ground water at borehole depths ranging between 30-300 feet deep. Such empirically determined heat transfer rates for a single 300 foot concentric-tube type ground heat exchanging system represents its estimated capacity to source and sink heat energy with the deep Earth environment (i.e. 30-300 feet deep), at the specified rate, expressed in units of Tons, or BTU/Hr, and also possibly, in units of BTUs/H, per linear foot of the concentric-tube type ground heat exchanger [BTUs/Hr-ft].

For small-scale projects (e.g. less than 15 Tons of heating or cooling), the ground loop design method the present invention teaches the ground loop designer to use such empirically-estimated heat transfer rate figures (published by the manufacturer in its GHE Library) to estimate how many 300 foot concentric-tube type ground heat exchanging systems, when installed 20 or so feet apart from each other in the loop field, will be required to construct a ground loop subsystem having a sufficient capacity to exchange heat energy with the Earth environment, to meet the requirements of the geothermal heat pump system to which it is connected. This average or estimated heat energy transfer rate Q_{ghe} of a single concentric-tube type ground heat exchanging system, provides a reliable measure on the “geo-exchange” or thermal power transfer capacity of a single ground heat exchanger.

For medium-to-large scale projects (e.g. greater than 15 Tons of heating or cooling), the ground loop design method the present invention teaches the ground loop designer/engineer to conduct an in situ heat transfer rate test on a single 300 foot test concentric-tube type ground heat Exchanging™ System installed at the loop field site. The heat transfer rate test can be carried out using the portable heat transfer rate test system disclosed herein. The purpose of this in situ heat transfer rate test is to empirically determine the actual rate of heat transfer performance of a single 300 foot concentric-tube type ground heat exchanging system, expressed in BTU/Hr, when constructed/installed in the particular loop field under construction. Using this empirically determined (maximum) heat transfer rate figure, for the given loop field under construction, or an equivalent heat transfer rate per linear foot of ground heat exchanger [BTUs/hr ft], the geothermal engineer can then quickly determine the optimal number (or linear feet) of concentric-tube type ground heat exchanging systems that must be installed in the loop field to construct a ground loop subsystem having a sufficient geo-exchange capacity, in the most economical manner technically possible.

The ground loop design method the present invention encourages the designer/engineer to allow for extra heat transfer rate capacity in each ground loop subsystem design, because this will provide a degree of thermal bank storage to the system.

Method of Designing and Constructing Small-Scale Geothermal Ground Loop Subsystems in Accordance with the Principles of the Present Invention

Multiple concentric-tube ground heat exchanger systems can be coupled together to construct small-scale geothermal ground loop subsystem (e.g. requiring less than 15 Tons of heat transfer capacity). In such design projects, the method of the present invention teaches using a simple non-recursive design/engineering method. The first step of the method involves determining the total thermal load of the geothermal system under design. In cooling dominant locations, this is achieved by computing the total HVAC thermal energy load (including Peak and Block Load calculations) of the building project. The total HVAC thermal energy load is then divided by the average heat transfer rate (HTR) of a single ground heat exchanging system installation (i.e. 5 Tons or 60,000 BTU/Hr), to determine the total number of 300 foot ground heat exchanging systems required to meet the maximum heat transfer rate requirements of the building project, in the cooling dominant location.

In heating dominant locations, the ground loop designer should confirm that the total factory-specified heating capacity of the ground source heat pump(s), and other supplementary, or auxiliary heating equipment sources to be used, are added up to meet the building heating load requirement. Once this is achieved, the ground loop designer divides this load figure by the average HTR of a single 300 feet ground heat exchanging system installation (i.e. 5 Tons or 60,000 BTU/Hr), to determine the total number of 300 foot ground heat exchanging systems required to meet the maximum heat transfer rate requirements of the building project in the heating dominant location.

Once the ground heat exchangers have been installed in their boreholes, they are connected together using conventional piping methods, to construct a geothermal ground loop subsystem that meets the heat transfer requirements of the geothermal system project.

### Method of Designing and Constructing Medium-To-Large Scale Geothermal Ground Loop Subsystems

Multiple ground heat exchanging systems can also be coupled together to construct medium-to-large scale geothermal ground loop subsystems (e.g. requiring more than 15 Tons of heat transfer capacity). In such design projects, the method of the present invention teaches the use a recursive-type design/engineering method. The first step involves computing the total thermal load of the geothermal system under design, as explained above. The second step of the method involves dividing the total thermal load figure by 5 Tons, to compute an approximate number of 300 foot ground heat exchanger to construct the ground loop subsystem for the geothermal system, where each ground heat exchanger is to be spaced at least 20 feet apart at the loop field location. The third step of the method seeks to fine tune the actual number of boreholes to be drilled at the loop field location, and in which ground heat exchanger systems will be installed, to construct an optimize ground loop subsystem for the estimated system load. The third step is carried out by installing a single 300 foot ground heat exchanger system at the actual loop field location for the project, and then empirically measuring the actual maximum heat transfer rate of the ground heat exchanging system, when installed at the particular loop field location. This empirically determined heat transfer rate measurement represents the long-term capacity of a single 300 foot concentric-tube type ground heat exchanging system installation to sink or source a maximal rate of heat energy with the Earth, in which it is installed. The geothermal system designer/engineer then uses the measured heat transfer rate of the test concentric-tube type ground heat exchanging system to accurately determine the optimal number of ground heat exchanging systems that will required to construct the complete geothermal ground loop subsystem for the geothermal project, at the given loop field locations.

When the loop field location is rich with underground aquifers or groundwater, the ground loop designer can expect that the heat transfer rate for the test ground heat exchanging system might typically measure greater than 5 Tons (60,000 BTU/Hr), and thus allowing for the previously estimated number of concentric-tube ground heat systems to be reduced, and providing for a more efficient and economical design. In those few geological locations around America, which are not rich in underground aquifers or groundwater, but nevertheless inhabited by humans, or are possibly bone or relatively dry, the ground loop designer can expect that actual maximum heat transfer rate of the test concentric-tube ground heat system to might measure as low as 4.0 Tons (i.e. 48,000 BTUs/Hr), and requiring an increase in the previously estimated number of concentric-tube ground heat systems, to ensure ground loop subsystem of sufficient and economized design.

Modifications that Readily Come to Mind

Having the benefit of the present invention disclosure, several modifications thereto readily come to mind.

For example, while the illustrative embodiments of the portable heat transfer rate test system of the present invention have employed an electrically-powered water heating elements using 230 Volt/100 Amp service delivered to the test site using J-cord, portable electrical power generators or the like, it is possible to use natural gas, propane or other combustion-type systems and techniques for heating the water stream flowing through the heat transfer rate test system to maintain a substantially constant inlet temperature Tᵢₙ while the water flow is maintained a constant flow rate during the long term testing operations. Alternatively, it is possible to adapt a water-to-water heat pump unit to supply heat energy to the water stream flowing through the heat transfer rate test system, to maintain a substantially constant inlet temperature Tᵢₙ.

Also, in some applications, it might be desirable to adapt the portable heat transfer rate test system to operate in a “heating mode”, in which the heat transfer rate test system will automatically cool (rather than heat) water flowing through its pumps to a predetermined constant inlet temperature Tᵢₙ, e.g. 35 [° F.]. In such an alternative embodiment, a refrigeration unit or a water-to-water heat pump can be integrated into the system for the purposes of cooling test ground loop water to a substantially constant inlet temperature Tᵢₙ=35 [° F.], during performance test operations.

Also, while the illustrative embodiments of the heat transfer rate test system and method of the present invention have been described in connection with concentric-tube (i.e. coaxial-flow) and HDPE U-Tube type ground heat exchangers, it is understood that the present invention can be used to measure the in situ performance or capacity of other closed types of ground heat exchangers, as well as open-type standing column well ground heat exchangers, well known in the art. Such open-type systems will require several modifications to the test system, including its energy balance model, to address the “open” nature of the system in which a constant flow of ground water is being pumped out of the system, while a new source of ground water is being pumped into the system.

Also, it is understood that the heat transfer rate test method of the present invention, including its enthalpy-based spreadsheet heat transfer rate calculator can also be used to measure the performance of ground source heat pumps and others systems installed in buildings and connected to underground heat exchangers.

It is understood that the heat transfer rate test apparatus and methodology of the present invention may be modified in a variety of ways which will become readily apparent to those skilled in the art of having the benefit of the novel teachings disclosed herein. All such modifications and variations of the illustrative embodiments thereof shall be deemed to be within the scope and spirit of the present invention as defined by the Claims to Invention appended hereto.

1-20. (canceled)

21. An enthalpy-based ground heat exchanger (GHE) performance test instrument system for connection to a ground heat exchanger (GHE) installed in a deep Earth environment and having inlet and outlet ports, said enthalpy-based GHE performance test instrument system comprising:
a ground loop pumping and heating module for pumping and heating aqueous-based heat transfer fluid through said GHE installation;
temperature transducers for measuring the temperature of said aqueous-based heat transfer fluid entering and leaving the inlet and outlet ports of said GHE installation during said performance testing operations, and generating temperature data representative of said temperature measurements;
pressure transducers for measuring the pressure of said aqueous-based heat transfer fluid entering and leaving said GHE installation during said performance testing operations, and generating pressure data representative of said pressure measurements;
a data logger/recorder, for logging and recording temperature and pressure data generated by said temperature and pressure transducers, respectively, during said performance testing operations;
a temperature control module for controlling the temperature of said aqueous-based heat transfer fluid exiting said enthalpy-based GHE performance test instrument system, and entering said GHE installation during said performance testing operations;
a flow rate control module for controlling the volumetric flow rate of water circulating through said GHE installation during said performance testing operations; and
a computer system interfaced with said data logger/recorder and running an enthalpy-based GHE performance program for calculating the heat transfer rate (HTR) performance of said GHE installation based on enthalpy principles.

22. A method of measuring the energy performance of a ground heat exchanger (GHE) installed in a deep Earth environment, comprising the steps of:
(a) connecting an enthalpy-based GHE performance test instrument system to said GHE installation to form a test ground loop;
(b) charging said test ground loop with a predetermined volume of said aqueous-based heat transfer fluid;
(c) using said enthalpy-based GHE performance test instrument system to heat and pump said aqueous-based heat transfer fluid through said test ground loop;
(d) using said enthalpy-based GHE performance test instrument system to control the temperature and flow rate of said aqueous-based heat transfer fluid circulating through said test ground loop;
(e) using said enthalpy-based GHE performance test instrument system to measure the inlet and outlet temperature and pressure of said aqueous-based heat transfer fluid entering and leaving said GHE installation during said performance testing operations, and generating inlet and outlet temperature and pressure data representative of said inlet and outlet temperature and pressure measurements;
(f) using said enthalpy-based GHE, performance test instrument system to log and record said inlet and outlet temperature and pressure data; and
(g) using said enthalpy-based GHE performance test instrument system to process said logged and recorded temperature and pressure data to calculate the heat transfer rate (HTR) performance of said GHE installation based on enthalpy principles.
